(19) United States
(12) Patent Application Publication
(10) Pub. No.: US 2025/0131381 A1
(43) Pub. Date: Apr. 24, 2025

(54) INFORMATION PROCESSING TERMINAL, INFORMATION PROCESSING METHOD, MANAGEMENT SYSTEM, MANAGEMENT METHOD, AND PROGRAM

(71) Applicant: Sony Group Corporation, Tokyo (JP)

(72) Inventors: Kei TSUZUKI, Kanagawa (JP); Masato KITA, Kanagawa (JP)

(73) Assignee: Sony Group Corporation, Tokyo (JP)

(21) Appl. No.: 18/682,605

(22) PCT Filed: Mar. 1, 2022
(86) PCT No.: PCT/JP2022/008513

§ 371 Date: Feb. 9, 2024

(30) Foreign Application Priority Data
Aug. 18, 2021 (JP) 2021-133097

(51) Int. Cl. G06Q 10/105; G06K 7/10

(52) U.S. Cl. CPC G06Q 10/105; G06K 7/10099

(57) ABSTRACT

There is provided an information processing terminal, an information processing method, a management system, a management method, and a program which are capable of improving convenience in a positioning process. A reading unit reads a tag ID from any one of a plurality of tags in which the tag ID for identifying each of the plurality of tags is recorded, the plurality of tags being arranged at a plurality of specific locations, respectively, in advance, and a positioning processing unit starts a positioning process in a case where the positioning process is not being executed and corrects a measured position in a case where the positioning process is being executed, by using position information of the tag when the reading unit reads the tag ID. The present technology can be applied to, for example, a positioning application that uses position information.

### TECHNICAL FIELD

The present disclosure relates to an information processing terminal, an information processing method, a management system, a management method, and a program, and more particularly, to an information processing terminal, an information processing method, a management system, a management method, and a program which are capable of improving convenience in a positioning process.

### BACKGROUND ART

Conventionally, applications for acquiring position information by executing a positioning process of measuring positions of users and using the position information in various use cases have been developed. For example, use cases such as employment management in an office (work area), checking of locations of employees in an office to cope with hot desking, grasping of a usage status of a desk or a meeting room, quantification of an amount of face-to-face communication between employees as a consultation tool from a personnel perspective, and contact tracing of an unspecified number of personnel are assumed for the applications using position information of users.

For example, Patent Document 1 proposes a seat management system capable of performing seat management without linking an ID unique to a seat layout with a seat in advance.

### CITATION LIST

### Patent Document

Patent Document 1: Japanese Patent Application Laid-Open No. 2017-138773

### SUMMARY OF THE INVENTION

### Problems to be Solved by the Invention

Meanwhile, in the above-described technology disclosed in Patent Document 1, a position of a user is not measured, and it is not possible to grasp the actual position of the user although it is possible to manage whether or not the user is at the seat. Furthermore, in a positioning system that measures a position of a user, conventionally, a start point at which positioning is started is fixed, or positioning accuracy is lowered as errors are accumulated due to a positioning process for a long time, and thus, there is a concern that convenience is low.

The present disclosure has been made in view of such a situation, and aims to improve convenience in a positioning process.

### Solutions to Problems

An information processing terminal according to a first aspect of the present disclosure includes: a reading unit that reads a tag ID from any one of a plurality of tags in which the tag ID for identifying each of the plurality of tags is recorded, the plurality of tags being arranged at a plurality of specific locations, respectively, in advance; and a positioning processing unit that starts a positioning process in a case where the positioning process is not being executed and corrects a measured position in a case where the positioning process is being executed, by using position information of the tag when the reading unit reads the tag ID.

An information processing method or a program according to the first aspect of the present disclosure includes: reading a tag ID from any one of a plurality of tags in which the tag ID for identifying each of the plurality of tags is recorded, the plurality of tags being arranged at a plurality of specific locations, respectively, in advance; and starting a positioning process in a case where the positioning process is not being executed and correcting a measured position in a case where the positioning process is being executed, by using position information of the tag when reading the tag ID.

In the first aspect of the present disclosure, the tag ID is read from any one of the plurality of tags in which the tag ID for identifying each of the plurality of tags is recorded, the plurality of tags being arranged at the plurality of specific locations, respectively, in advance, and the positioning process is started in a case where the positioning process is not being executed or the measured position is corrected in a case where the positioning process is being executed, by using the position information of the tag when the tag ID is read.

A management system according to a second aspect of the present disclosure includes: an information processing terminal including: a reading unit that reads a tag ID from any one of a plurality of tags in which the tag ID for identifying each of the plurality of tags is recorded, the plurality of tags being arranged at a plurality of specific locations, respectively, in advance; and a positioning processing unit that starts a positioning process in a case where the positioning process is not being executed and corrects a measured position in a case where the positioning process is being executed, by using position information of the tag when the reading unit reads the tag ID; a server that registers user IDs and attendance statuses of employees of a plurality of the information processing terminals transmitted from the plurality of information processing terminals or the user IDs and current positions of the employees of the plurality of information processing terminals transmitted from the plurality of information processing terminals; and an administrator terminal that makes an inquiry to the server and manages an attendance status and a current position of an employee for each of the plurality of information processing terminals.

A management method and a program according to the second aspect of the present disclosure, performed by a computer of a management system, which includes: an information processing terminal including: a reading unit that reads a tag ID from any one of a plurality of tags in which the tag ID for identifying each of the plurality of tags is recorded, the plurality of tags being arranged at a plurality of specific locations, respectively, in advance; and a positioning processing unit that starts a positioning process in a case where the positioning process is not being executed and corrects a measured position in a case where the positioning process is being executed, by using position information of the tag when the reading unit reads the tag ID; a server; and an administrator terminal, the management method and the program including: registering user IDs and attendance statuses of employees of a plurality of the information processing terminals transmitted from the plurality of information processing terminals to the server or the user IDs and current positions of the employees of the plurality of information processing terminals transmitted from the plurality of information processing terminals to the server; and causing the administrator terminal to make an inquiry to the server to manage an attendance status and a current position of an employee for each of the plurality of information processing terminals.

In the second aspect of the present disclosure, the management system includes the information processing terminal, the server, and the administrator terminal, the information processing terminal including: the reading unit that reads the tag ID from any one of the plurality of tags in which the tag ID for identifying each of the plurality of tags is recorded, the plurality of tags being arranged at the plurality of specific locations, respectively, in advance; and the positioning processing unit that starts the positioning process in a case where the positioning process is not being executed and corrects the measured position in a case where the positioning process is being executed, by using the position information of the tag when the reading unit reads the tag ID. Then, the user IDs and the attendance statuses of the employees of the information processing terminals transmitted from the information processing terminals to the server, or the user IDs and the current positions of the employees of the information processing terminals transmitted from the information processing terminals to the server are registered, and the administrator terminal makes an inquiry to the server to manage the attendance status and the current position of the employee for each of the information processing terminals.

### BRIEF DESCRIPTION OF DRAWINGS

FIG. 1 is a view illustrating an outline of a positioning system.

FIG. 2 is a diagram illustrating a configuration example of a first embodiment of the positioning system to which the present technology is applied.

FIG. 3 is a block diagram illustrating a configuration example of a mobile terminal.

FIG. 4 is a view illustrating display examples of display screens displayed at the start and during execution of a positioning process.

FIG. 5 is a view illustrating display examples of display screens displayed in an association process.

FIG. 6 is a view illustrating display examples of display screens displayed in the association process.

FIG. 7 is a flowchart describing the association process.

FIG. 8 is a flowchart illustrating a user position information notification process.

FIG. 9 is a diagram illustrating a configuration example of a second embodiment of the positioning system to which the present technology is applied.

FIG. 10 is a view illustrating display examples of display screens displayed in a writing process.

FIG. 11 is a view illustrating display examples of display screens displayed in the writing process.

FIG. 12 is a view illustrating display examples of display screens displayed in the writing process.

FIG. 13 is a flowchart describing the writing process.

FIG. 14 is a flowchart illustrating a user position information notification process.

FIG. 15 is a view for describing orientations of an NFC tag.

FIG. 16 is a view illustrating display examples of display screens displayed in the writing process.

FIG. 17 is a view illustrating display examples of display screens displayed in the writing process.

FIG. 18 is a flowchart for illustrating the positioning process.

FIG. 19 is a block diagram illustrating a configuration example of an employee management system.

FIG. 20 is a view illustrating an example of a checking screen for an attendance status and a current position.

FIG. 21 is a sequence diagram illustrating an employee management process.

FIG. 22 is a block diagram illustrating a configuration example of an embodiment of a computer to which the present technology is applied.

### MODE FOR CARRYING OUT THE INVENTION

Hereinafter, specific embodiments to which the present technology is applied will be described in detail with reference to the drawings.

### <Outline of Positioning System>

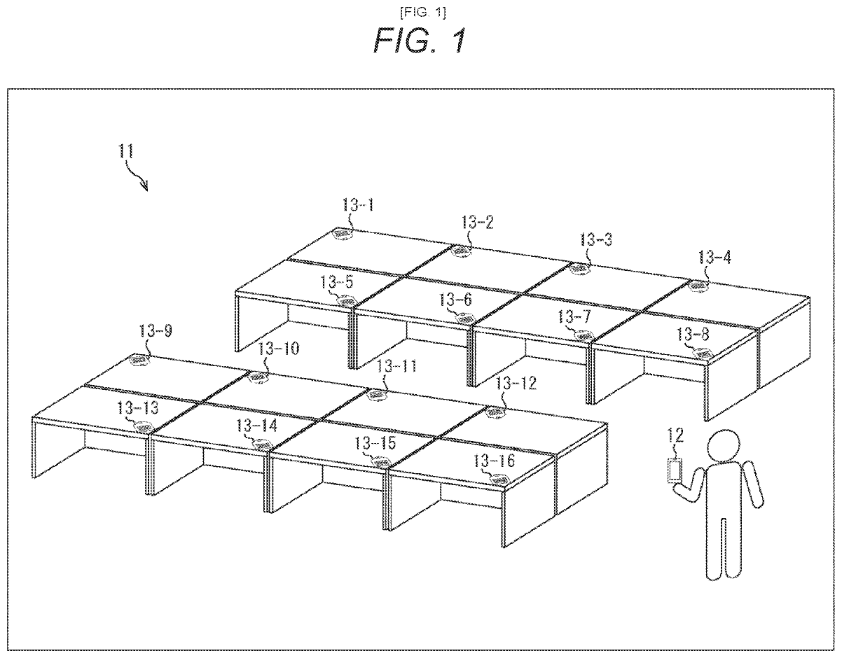

An outline of a positioning system to which the present technology is applied will be described with reference to FIG. 1.

A positioning system 11 as illustrated in FIG. 1 acquires user position information by executing a positioning process of measuring a position of a user who possesses a mobile terminal 12, and issues a notification to an application (hereinafter, referred to as a positioning application) that uses the user position information. Furthermore, in the positioning system 11, pieces of position information (hereinafter, referred to as tag position information) of NFC tags 13 arranged in advance with respect to a plurality of desks are used for the positioning process, and NFC tags 13-1 to 13-16 are attached to sixteen desks in the example illustrated in FIG. 1.

For example, when the user touches any one of the NFC tags 13-1 to 13-16 with the mobile terminal 12 in a state where the positioning application is not activated, the positioning system 11 activates the positioning application. Then, the positioning system 11 acquires the tag position information of the NFC tag 13 touched by the mobile terminal 12, starts the positioning process with a position indicated by the tag position information as a positioning start position, and notifies the positioning application of the user position information.

Thereafter, the positioning system 11 can perform the positioning process using, for example, positioning technologies such as pedestrian dead reckoning (PDR), geomagnetism, and a beacon. In addition, the positioning system 11 may perform the positioning process using an imaging device, an ultra wide band (UWB), and the like.

Moreover, when the user touches any one of the NFC tags 13-1 to 13-16 with the mobile terminal 12 during the execution of the positioning process, the positioning system 11 acquires tag position information associated with the NFC tag 13 touched by the mobile terminal 12. Then, the positioning system 11 corrects the user position information with the tag position information and notifies the positioning application of the corrected user position information.

Such a positioning system 11 can realize the positioning process of acquiring user position information that is used in various use cases as described above. For example, since the positioning process is started when the user touches any NFC tag 13 with the mobile terminal 12 in the positioning system 11, convenience can be enhanced as compared with a positioning process in which a start point is fixed. Furthermore, since the user position information is corrected with the tag position information of the NFC tag 13 in the positioning system 11, when the user touches the NFC tag 13 with the mobile terminal 12 during the execution of the positioning process, it is possible to avoid a decrease in positioning accuracy even in the positioning process for a long time.

Here, as the tag position information of the NFC tag 13 (tag position information associated with a tag ID of the NFC tag 13 or tag position information written in an NFC tag 13A as described later), for example, latitude and longitude information indicated by world coordinates, a coordinate in a building or a room indicated by a local coordinate system, or the like is used. Furthermore, the tag position information may include height information, and a floor number in a building of a plurality of floors can be used. Moreover, as the tag position information, information indicating any room among a plurality of rooms in a building and information indicating any seat in the room may be used. In addition, an installation company name, installation date and time, position information update date and time, and the like may be recorded together with the tag position information.

### <First Configuration Example of Positioning System>

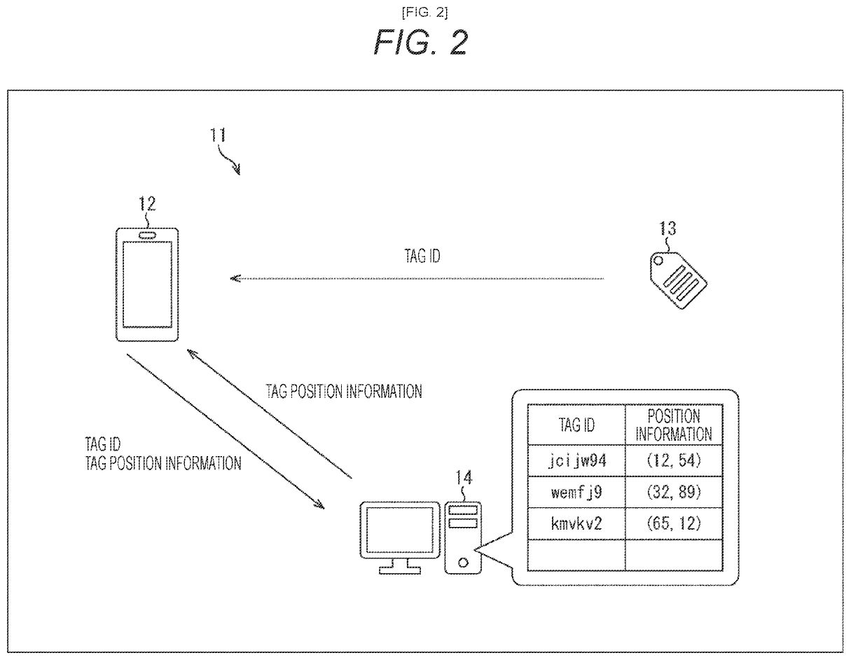

FIG. 2 is a diagram illustrating a configuration example of a first embodiment of the positioning system to which the present technology is applied.

As illustrated in FIG. 2, the positioning system 11 includes the mobile terminal 12, the NFC tag 13, and a server 14. Note that a plurality of the NFC tags 13 is used in the positioning system 11 as described with reference to FIG. 1.

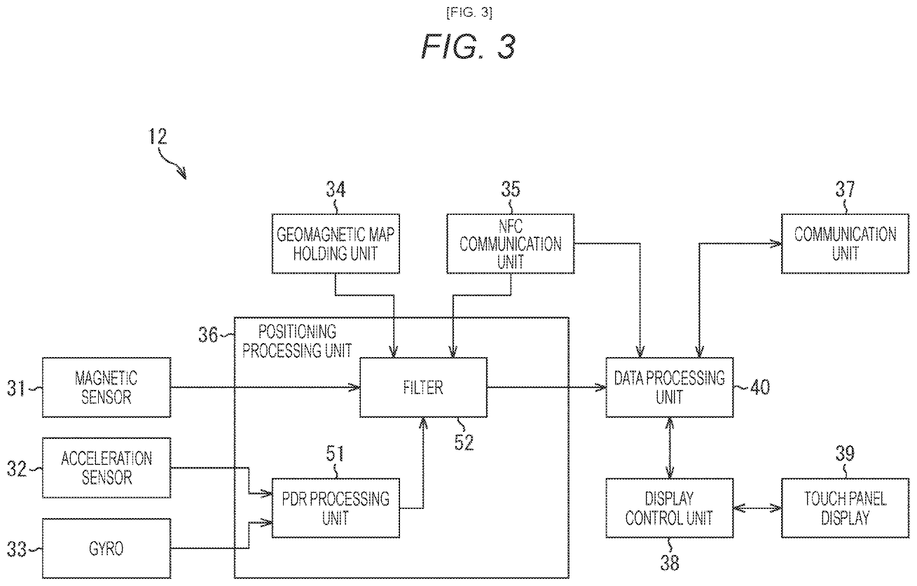

The mobile terminal 12 can perform NFC communication with the NFC tag 13 in a short distance of several cm or less, for example, and can communicate with the server 14 via a portable communication network. Note that a detailed configuration of the mobile terminal 12 will be described later with reference to a block diagram illustrated in FIG. 3.

In the NFC tag 13, a tag identification (ID) for identifying itself is recorded. When the user touches the NFC tag 13 with the mobile terminal 12, the mobile terminal 12 can read the tag ID from the NFC tag 13 by NFC communication.

The server 14 holds a database that stores pieces of association information in which tag IDs are associated with pieces of tag position information, respectively. For example, when an association process of associating a tag ID with tag position information is performed, the server 14 registers, in the database, association information (a set of the tag ID and the tag position information) transmitted from the mobile terminal 12. Furthermore, when a user position information notification process of notifying the positioning application of user position information, the server 14 transmits tag position information associated with a tag ID to the mobile terminal 12 if receiving the tag ID transmitted from the mobile terminal 12.

FIG. 3 is the block diagram illustrating a configuration example of the mobile terminal 12.

As illustrated in FIG. 3, the mobile terminal 12 includes a magnetic sensor 31, an acceleration sensor 32, a gyro 33, a geomagnetic map holding unit 34, an NFC communication unit 35, a positioning processing unit 36, a communication unit 37, a display control unit 38, a touch panel display 39, and a data processing unit 40.

The magnetic sensor 31 detects and outputs magnetism at a current position of the mobile terminal 12, the acceleration sensor 32 detects and outputs an acceleration of the mobile terminal 12, and the gyro 33 detects and outputs an angular velocity of the mobile terminal 12. The geomagnetic map holding unit 34 holds a geomagnetic map for performing positioning using the magnetism detected by the magnetic sensor 31.

The NFC communication unit 35 performs NFC communication in a short distance of several cm or less with the NFC tag 13.

For example, the NFC communication unit 35 is a reading unit that reads the tag ID from the NFC tag 13.

The positioning processing unit 36 measures a position of the mobile terminal 12 to acquire user position information. For example, the positioning processing unit 36 includes a PDR processing unit 51 and a filter 52, PDR processing is performed by the PDR processing unit 51 using the outputs of the acceleration sensor 32 and the gyro 33, and a current position obtained as a processing result is supplied to the filter 52. The filter 52 applies a filter to the current position supplied from the PDR processing unit 51 and a current position obtained by associating the output of the magnetic sensor 31 with the geomagnetic map, and outputs a current position obtained as a result thereof.

Furthermore, the positioning processing unit 36 uses the tag position information of the NFC tag 13 read by the NFC communication unit 35 as an initial position of the user position information at the start of the positioning process, and corrects the user position information with the tag position information of the NFC tag 13 read by the NFC communication unit 35 during the execution of the positioning process.

The communication unit 37 communicates with the server 14 to transmit the tag ID to the server 14 and receive the tag position information transmitted from the server 14, for example.

The display control unit 38 controls a display on the touch panel display 39.

The touch panel display 39 displays each of display screens as described later and detects a touch operation of the user under the control of the display control unit 38.

The data processing unit 40 performs data processing necessary for the positioning process using the user position information measured by the positioning processing unit 36, the tag ID read from the NFC tag 13 by the NFC communication unit 35, the tag position information received by the communication unit 37, and the like.

### <Display Examples of Display Screens>

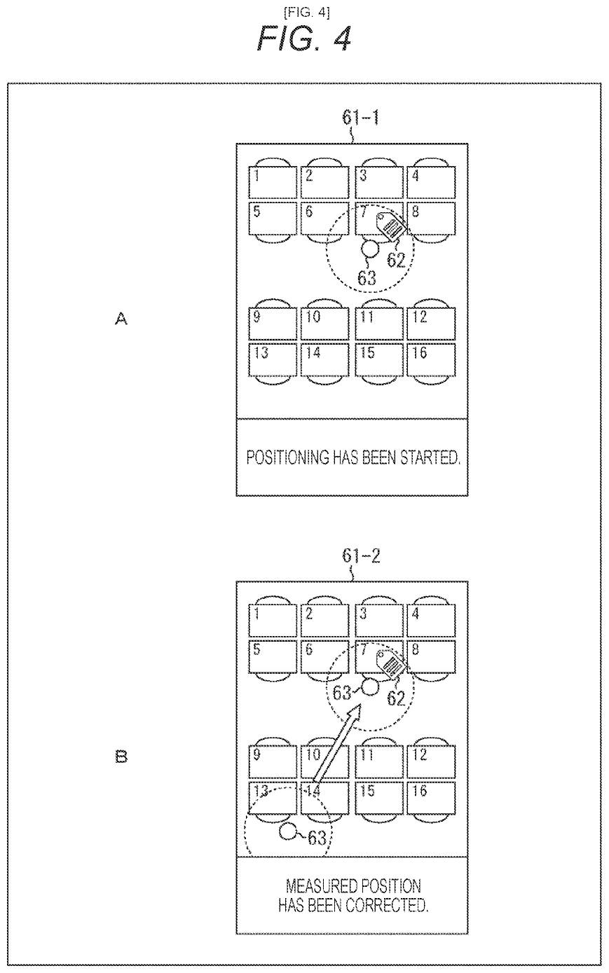

Display screens displayed on the touch panel display 39 at the start and during the execution of the positioning process will be described with reference to FIG. 4.

For example, in the positioning system 11 using the NFC tags 13-1 to 13-16 as illustrated in FIG. 1, a display screen 61 on which a map in which images of sixteen desks are arranged is displayed is displayed on the touch panel display 39 so as to correspond to the desks to which the NFC tags 13-1 to 13-16 are attached, respectively.

A of FIG. 4 illustrates an example of a display screen 61-1 displayed on the touch panel display 39 when the user touches the NFC tag 13 with the mobile terminal 12 so that the positioning process is started.

For example, a case where the user touches the NFC tag 13-7 with the mobile terminal 12 so that the positioning process is started will be described. In this case, on a map of the display screen 61-1, a tag mark 62 is displayed so as to be superimposed on the image of the desk to which the NFC tag 13-7 is attached, and a positioning mark 63 based on the user position information is displayed in the vicinity of the image of the desk. Then, a message “Positioning has been started.” to issue a notification that the positioning process has been started is displayed on the display screen 61-1.

B of FIG. 4 illustrates an example of a display screen 61-2 displayed on the touch panel display 39 when the user touches the NFC tag 13 with the mobile terminal 12 so that the user position information is corrected during the execution of the positioning process.

For example, a case where the user has touched the NFC tag 13-7 with the mobile terminal 12 when the positioning mark 63 immediately before correction of the user position information is performed is displayed in the vicinity of the lower left corner on a map of the display screen 61-2 will be described. In this case, on the map of the display screen 61-2, the tag mark 62 is displayed so as to be superimposed on the image of the desk to which the NFC tag 13-7 is attached, and a display position of the positioning mark 63 is changed from the vicinity of the lower left corner of the display screen 61-2 to the vicinity of the tag mark 62. Then, on the display screen 61-2, a message “measured position has been corrected.” to issue a notification that the user position information has been corrected is displayed.

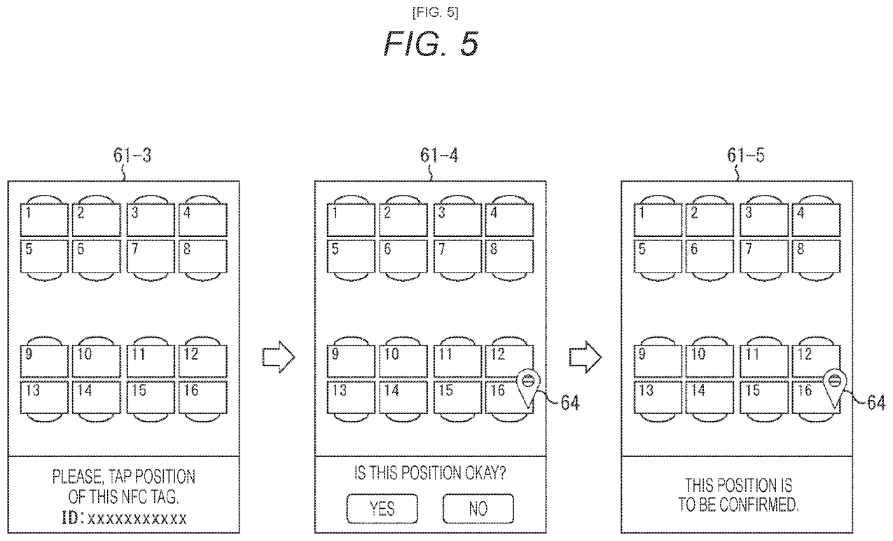

FIG. 5 illustrates display examples of display screens 61-3 to 61-5 displayed on the touch panel display 39 when tag position information is not associated with a tag ID of the NFC tag 13 on which the user has touched the mobile terminal 12 yet in the association process of associating a tag ID with tag position information.

In FIG. 5, a case where the user touches the NFC tag 13-16 with the mobile terminal 12 during execution of the association process will be described. In this case, on the display screen 61-3, a tag ID of the touched NFC tag 13 is displayed together with a message “Please tap position of this NFC tag.” to prompt designation of position information to be associated with the NFC tag 13 on which the user has touched the mobile terminal 12.

When the user taps on a position of the NFC tag 13-16 on a map of the display screen 61-3 and performs a designation operation of designating the position information to be associated with the NFC tag 13 in response to the message, the display of the touch panel display 39 is changed to the display screen 61-4. On a map of the display screen 61-4, a pin mark 64 indicating the NFC tag 13-16 is displayed at a display position according to the designation by the user, for example, at a display position superimposed on the image of the desk to which the NFC tag 13-16 is attached. Then, on the display screen 61-4, a message “Is this position OK?” to check whether the display position indicated by the pin mark 64 is correct, and a “Yes” button and a “No” button are displayed.

When the user taps the “Yes” button in response to this message, the display of the touch panel display 39 is changed to the display screen 61-5, and a message “This position is to be confirmed.” to confirm the position information to be associated with the tag ID of the NFC tag 13-16 according to a position of the pin mark 64 is displayed.

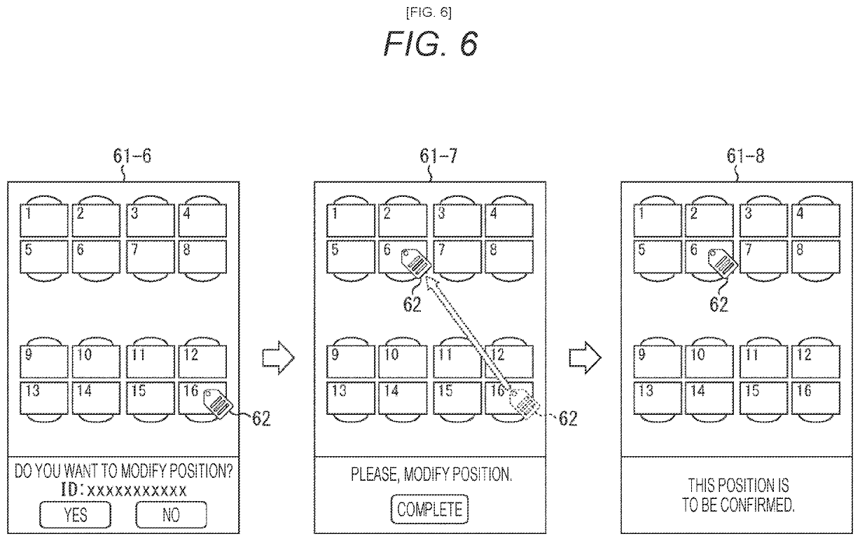

FIG. 6 illustrates display examples of display screens 61-6 to 61-8 displayed on the touch panel display 39 when tag position information has been associated with a tag ID of the NFC tag 13 on which the user has touched the mobile terminal 12 in the association process of associating a tag ID with tag position information.

In FIG. 6, a case where the tag position information of the NFC tag 13-6 is associated with the tag ID of the NFC tag 13-16 on which the user has touched the mobile terminal 12 during the execution of the association process will be described. In this case, on a map of the display screen 61-6, the tag mark 62 is displayed at a display position according to the tag position information of the NFC tag 13-16. Moreover, on the display screen 61-6, the tag ID of the touched NFC tag 13-6, and a “Yes” button and a “No” button are displayed together with a message “Do you want to modify position?” to check whether or not to modify the display position of the tag mark 62.

When the user taps the “Yes” button in response to the message, the display of the touch panel display 39 is changed to the display screen 61-7. On the display screen 61-7, a “Complete” button is displayed together with a message “Please modify position.” to prompt modification of the display position of the tag mark 62. In response to this message, the user performs a modification operation of modifying the display position of the tag mark 62 by moving (dragging) the tag mark 62 to the display position according to the position of the NFC tag 13-6 while touching the tag mark 62 at the current display position.

Thereafter, when the user taps the “Complete” button, the display of the touch panel display 39 is changed to the display screen 61-8, and a message “This position is to be confirmed.” to confirm the modification of the tag position information to be linked with the tag ID of the NFC tag 13-6 according to the tag mark 62 is displayed.

### <Processing Examples of Association Process and User Position Information Notification Process>

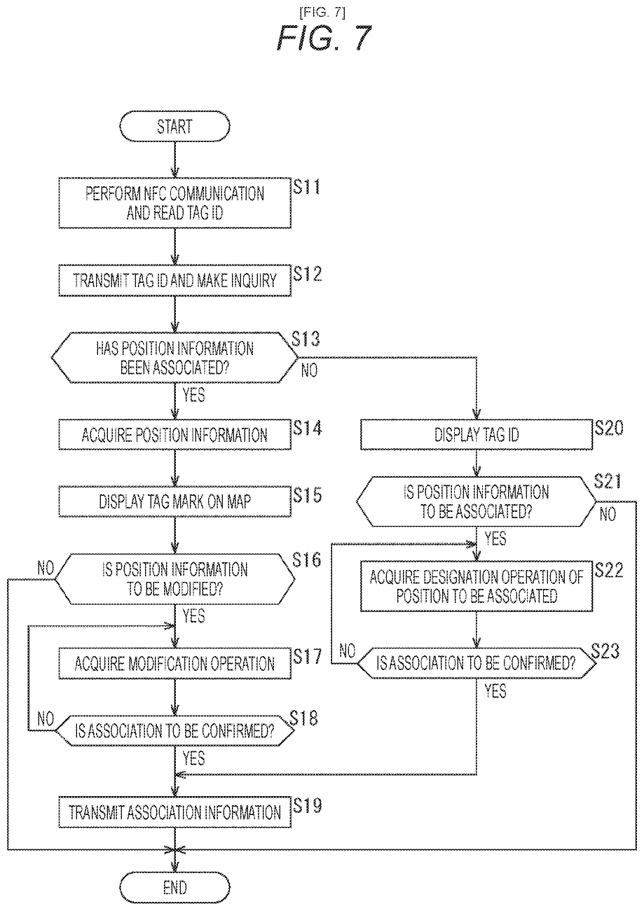

The association process of associating a tag ID with tag position information will be described with reference to a flowchart illustrated in FIG. 7.

For example, processing is started when the mobile terminal 12 touches any NFC tag 13. In step S11, the NFC communication unit 35 performs NFC communication with the NFC tag 13 and reads a tag ID of the NFC tag 13 touched by the mobile terminal 12.

In step S12, the communication unit 37 transmits the tag ID read by the NFC communication unit 35 in step S11 to the server 14, and inquires about whether or not tag position information has been associated with the tag ID. Then, when the communication unit 37 receives a response transmitted from the server 14 in response to the inquiry, the processing proceeds to step S13.

In step S13, the data processing unit 40 determines whether or not tag position information has been associated with the tag ID read by the NFC communication unit 35 in step S11 in accordance with the response of the server 14 received by the communication unit 37 in step S12.

In step S13, in a case where the data processing unit 40 determines that tag position information has been associated with the tag ID, the processing proceeds to step S14.

In step S14, the communication unit 37 communicates with the server 14, and acquires the tag position information of the tag ID read by the NFC communication unit 35 in step S11.

In step S15, the display control unit 38 displays the tag mark 62 on the map of the display screen 61 at a display position according to the tag position information of the tag ID acquired by the communication unit 37 in step S14 (see the display screen 61-6 in FIG. 6).

In step S16, the data processing unit 40 determines whether or not to modify the tag position information of the NFC tag 13 touched by the mobile terminal 12.

In step S16, in a case where the data processing unit 40 determines to modify the tag position information of the NFC tag 13, for example, in a case where the user operates the “Yes” button displayed on the display screen 61-6 of FIG. 6, the processing proceeds to step S17.

In step S17, when the user performs a modification operation of modifying the display position of the tag mark 62, the touch panel display 39 acquires the modification operation as described with reference to the display screen 61-7 illustrated in FIG. 6. Then, the display control unit 38 performs display control on the touch panel display 39 so as to display the tag mark 62 at the display position according to the modification operation.

In step S18, the data processing unit 40 modifies the tag position information of the NFC tag 13 touched by the mobile terminal 12 with a position according to the display position modified by the modification operation acquired in step S17, and determines whether to confirm association of the modified tag position information with the tag ID of the NFC tag 13.

In step S18, in a case where the data processing unit 40 determines to confirm the association of the modified tag position information, for example, in a case where the user operates the “Complete” button displayed on the display screen 61-7 of FIG. 6, the processing proceeds to step S19. Note that the acquisition of the modification operation in step S17 is continuously performed until it is determined to confirm the association of the modified tag position information, for example, until the “Complete” button displayed on the display screen 61-7 in FIG. 6 is operated.

In step S19, the communication unit 37 acquires current position information of the mobile terminal 12 from the positioning processing unit 36, and transmits association information associated with the tag ID read by the NFC communication unit 35 in step S11 to the server 14 using the position information as tag position information. Thereafter, in the server 14, the database is updated with the association information transmitted from the mobile terminal 12, and the processing is ended.

On the other hand, in a case where the data processing unit 40 determines that tag position information is not associated with the tag ID yet in step S13, the processing proceeds to step S20.

In step S20, the display control unit 38 displays the tag ID read by the NFC communication unit 35 in step S11 on the touch panel display 39 (see the display screen 61-3 in FIG. 5).

In step S21, the data processing unit 40 determines whether or not to associate tag position information with the tag ID, and the processing proceeds to step S22 in a case where it is determined to associate tag position information with the tag ID.

In step S22, when the user performs a designation operation of designating position information to be associated with the NFC tag 13, the touch panel display 39 acquires the designation operation as described with reference to the display screen 61-4 illustrated in FIG. 5.

In step S23, the data processing unit 40 determines whether or not to confirm the association of tag position information with the tag ID of the NFC tag 13 using a position according to a display position designated by the designation operation acquired by the touch panel display 39 in step S22 as the tag position information of the NFC tag 13 touched by the mobile terminal 12.

In step S23, in a case where the data processing unit 40 determines to confirm the association of the tag position information with the tag ID, for example, in a case where the user operates the “Yes” button displayed on the display screen 61-4 of FIG. 5, the processing proceeds to step S19. In this case, in the server 14, the association information transmitted from the mobile terminal 12 in step S19 is registered in the database, and the processing is ended. Note that the acquisition of the designation operation in step S22 is continuously performed until it is determined to confirm the association, for example, until the “Yes” button displayed on the display screen 61-4 in FIG. 5 is operated.

On the other hand, the processing is ended in a case where the data processing unit 40 determines not to modify the tag position information of the NFC tag 13 in step S16 or determines not to associate tag position information with the NFC tag 13 in step S21.

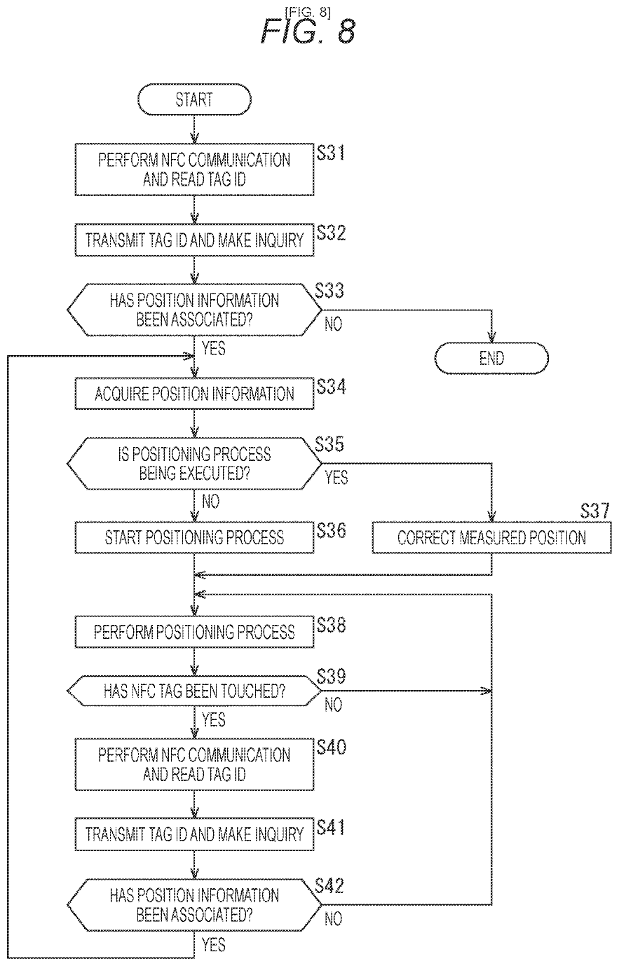

The user position information notification process will be described with reference to a flowchart illustrated in FIG. 8.

For example, processing is started when the mobile terminal 12 touches any NFC tag 13. In step S31, the NFC communication unit 35 performs NFC communication with the NFC tag 13 and reads a tag ID of the NFC tag 13 touched by the mobile terminal 12.

In step S32, the communication unit 37 transmits the tag ID read by the NFC communication unit 35 in step S31 to the server 14, and inquires about whether or not tag position information has been associated with the tag ID. Then, when the communication unit 37 receives a response transmitted from the server 14 in response to the inquiry, the processing proceeds to step S33.

In step S33, the data processing unit 40 determines whether or not tag position information has been associated with the tag ID read by the NFC communication unit 35 in step S31 in accordance with the response of the server 14 received by the communication unit 37 in step S32. In step S33, in a case where it is determined that tag position information is not associated with the tag ID yet, the processing is ended.

On the other hand, in a case where the data processing unit 40 determines in step S33 that tag position information has been associated with the tag ID, the processing proceeds to step S34.

In step S34, the communication unit 37 communicates with the server 14, and acquires the tag position information of the tag ID read by the NFC communication unit 35 in step S31.

In step S35, the data processing unit 40 determines whether or not the positioning process by the positioning processing unit 36 is being executed.

In step S35, in a case where the data processing unit 40 determines that the positioning process by the positioning processing unit 36 is not being executed, the processing proceeds to step S36. In step S36, the positioning processing unit 36 starts the positioning process using the tag position information acquired by the communication unit 37 in step S34 as an initial position, and notifies the positioning application of user position information.

On the other hand, in a case where the data processing unit 40 determines in step S35 that the positioning process by the positioning processing unit 36 is being executed, the processing proceeds to step S37. In step S37, the positioning processing unit 36 corrects the user position information acquired in the immediately preceding positioning process with the tag position information acquired by the communication unit 37 in step S34, and notifies the positioning application of corrected user position information.

After the process of step S36 or S37, the processing proceeds to step S38, and the positioning processing unit 36 performs the positioning process based on outputs of the magnetic sensor 31, the acceleration sensor 32, and the gyro 33, acquires user position information at a predetermined measurement cycle, and notifies the positioning application of the user position information.

In step S39, the NFC communication unit 35 determines whether or not the mobile terminal 12 has touched the NFC tag 13. In a case where it is determined in step S39 that the mobile terminal 12 has not touched the NFC tag 13, the processing returns to step S38, and the positioning process by the positioning processing unit 36 is continuously performed.

On the other hand, the processing proceeds to step S40 in a case where the NFC communication unit 35 determines that the mobile terminal 12 has touched the NFC tag 13 in step S39.

In steps S40 to S42, processes similar to those of steps S31 to S33 described above are performed. Then, in step S42, in a case where the data processing unit 40 determines that tag position information has been associated with a tag ID, the processing returns to step S34, and similar processing is repeatedly performed subsequently.

On the other hand, in a case where it is determined in step S42 that tag position information is not associated with the tag ID yet, the processing returns to step S38, and the positioning process by the positioning processing unit 36 is continuously performed.

As described above, in the positioning system 11, the positioning process can be started by touching the NFC tag 13 with the mobile terminal 12, and the user position information (measured position) can be corrected with the tag position information when the NFC tag 13 is touched with the mobile terminal 12 during the execution of the positioning process. Therefore, the positioning system 11 can realize highly accurate indoor positioning.

Furthermore, the positioning system 11 can provide the positioning process with low cost and high convenience, for example, as compared with a positioning system in which a large number of Bluetooth (registered trademark) Low Energy (BLE) beacons are installed. Furthermore, as compared with a conventional positioning process only using PDR processing and geomagnetism, the positioning system 11 can avoid accumulation of errors, and thus, can enhance the positioning accuracy. Furthermore, as compared with a positioning process in which a start point at which positioning is started is fixed, the positioning system 11 can start the positioning process from any location, and thus, can enhance the convenience.

Note that, in a first configuration example of the positioning system 11, a tag in which a tag ID is described as a two-dimensional barcode may be used in addition to the NFC tag 13. In this case, the mobile terminal 12 is only required to have a reader function of reading the tag ID from the two-dimensional barcode.

Furthermore, an NFC reader may be used instead of the NFC tag 13, but it is preferable to use the NFC tag 13 from the viewpoint of power consumption. For example, the NFC reader may be used only in the vicinity of a door of a room to manage entry and exit.

### <Second Configuration Example of Positioning System>

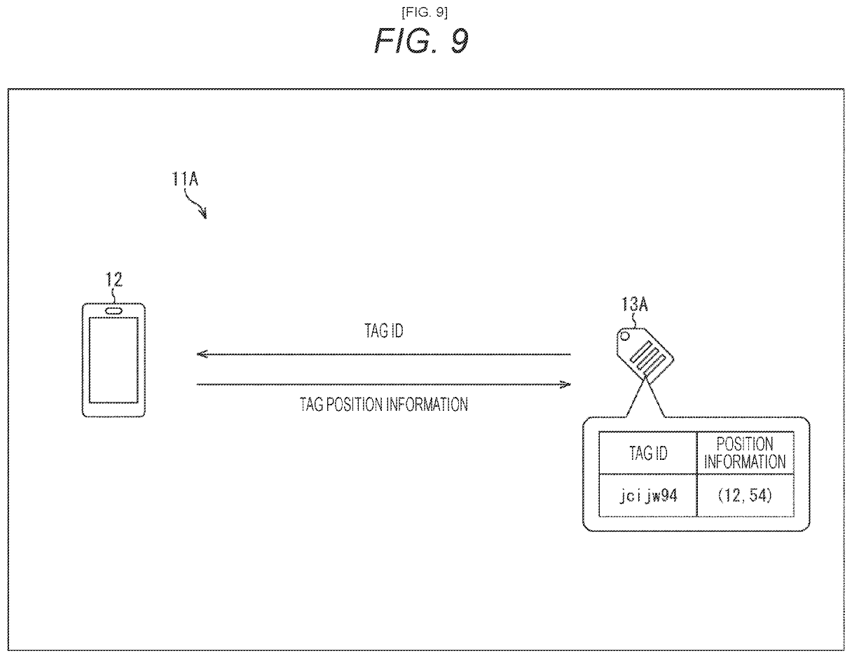

FIG. 9 is a diagram illustrating a configuration example of a second embodiment of the positioning system to which the present technology is applied.

As illustrated in FIG. 9, a positioning system 11A includes the mobile terminal 12 and an NFC tag 13A. Note that a plurality of the NFC tags 13A is used in the positioning system 11A as described with reference to FIG. 1. Furthermore, the mobile terminal 12 is configured similarly to the mobile terminal 12 described with reference to FIG. 3.

In the NFC tag 13A, a tag ID for identifying itself is recorded. Moreover, the NFC tag 13A can write its own tag position information in linkage with the tag ID by performing NFC communication with the mobile terminal 12.

For example, in the positioning system 11A, if a user touches the NFC tag 13A with the mobile terminal 12 while a writing process of writing tag position information in the NFC tag 13A is being performed, the mobile terminal 12 can transmit the tag position information to be written in the NFC tag 13A by NFC communication.

Furthermore, in the positioning system 11A, if the user touches the NFC tag 13A with the mobile terminal 12 when a user position information notification process of notifying a positioning application of user position information is performed, the mobile terminal 12 can read the tag position information from the NFC tag 13A by NFC communication.

### <Display Examples of Display Screens>

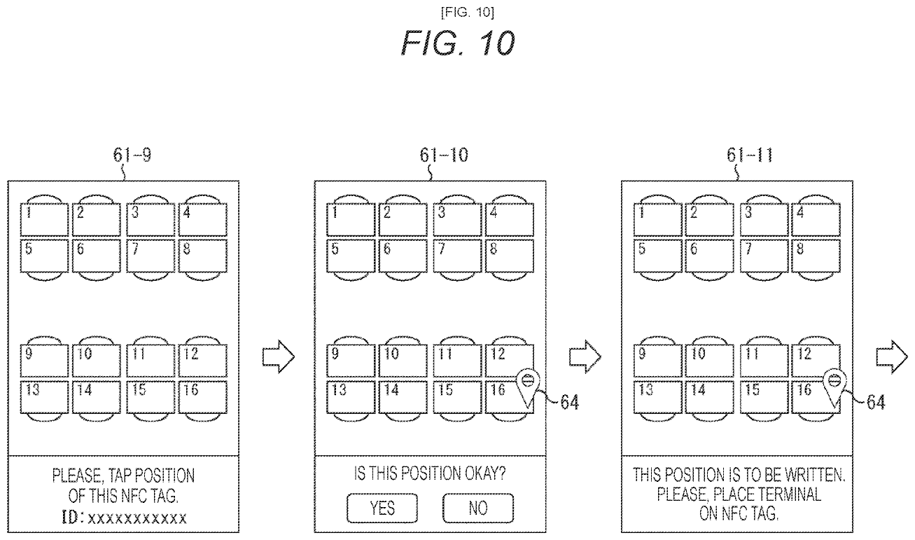

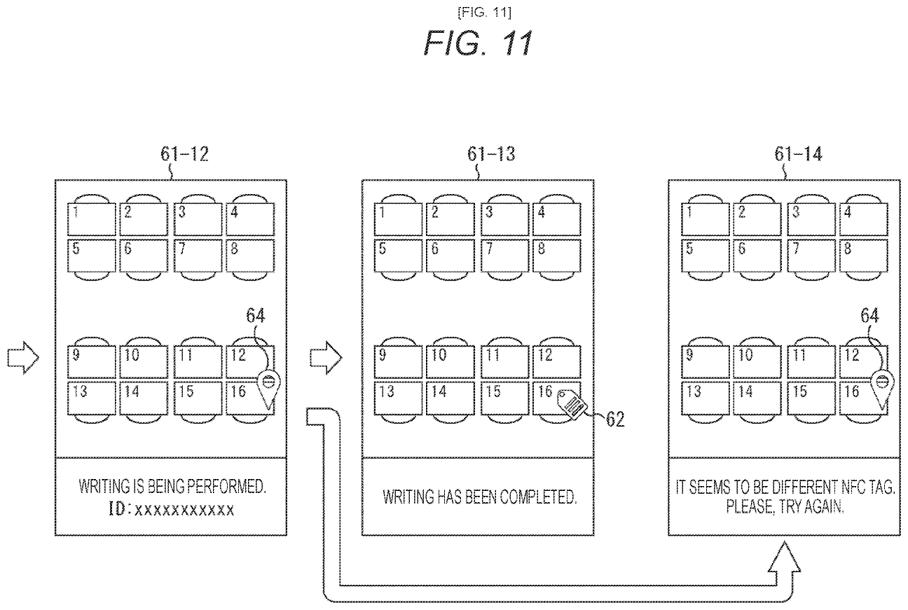

FIGS. 10 and 11 illustrate display examples of display screens 61-9 to 61-14 displayed on the touch panel display 39 when tag position information is not written in the NFC tag 13A on which the user has touched the mobile terminal 12 in the writing process of writing tag position information.

In FIGS. 10 and 11, a case where the user touches an NFC tag A13A-16 with the mobile terminal 12 during execution of the writing process will be described. In this case, on the display screen 61-9, a tag ID of the touched NFC tag 13A is displayed together with a message “Please tap position of this NFC tag.” to prompt designation of position information to be written in the NFC tag 13A on which the user has touched the mobile terminal 12.

When the user taps on a position of the NFC tag 13A-16 on a map of the display screen 61-9 and performs a designation operation of designating the position information to be written in the NFC tag 13A in response to the message, the display of the touch panel display 39 is changed to the display screen 61-10.

On a map of the display screen 61-10, the pin mark 64 indicating the NFC tag 13-16 is displayed at a display position according to the designation by the user, for example, at a display position superimposed on an image of a desk to which the NFC tag 13-16 is attached. Then, on the display screen 61-10, a message “Is this position OK?” to check whether the display position indicated by the pin mark 64 is correct, and a “Yes” button and a “No” button are displayed.

When the user taps the “Yes” button in response to this message, the display of the touch panel display 39 is changed to the display screen 61-11, and a message “This position is to be written. Please, place terminal on NFC tag.” to confirm that the position information is to be written in the NFC tag 13A-16 according to the position of the pin mark 64 is displayed.

When the user touches the mobile terminal 12 on the NFC tag 13A-16 in response to this message, the display of the touch panel display 39 is changed to the display screen 61-12, and a message “Writing is being performed” to issue a notification that the tag position information is being written in the NFC tag 13A-16 is displayed. At this time, the mobile terminal 12 reads a tag ID from the NFC tag 13A-16 that has been touched in order to write the tag position information, and displays the tag ID together with the message.

At this time, for example, in a case where the tag ID read by the first touch is the same as the tag ID read by the touch for writing of the tag position information, the writing of the tag position information in the NFC tag 13A-16 is normally performed. Therefore, in this case, the display of the touch panel display 39 is changed to the display screen 61-13, and a message “Writing has been completed.” to issue a notification that the writing of the tag position information has been completed is displayed.

However, for example, in a case where the tag ID read by the first touch is not the same as the tag ID read by the touch for writing of the tag position information, the writing of the tag position information in the NFC tag 13A-16 is not performed. Therefore, in this case, the display of the touch panel display 39 is changed to the display screen 61-14, and a message “It seems to be different NFC tag. Please, try again.” to prompt retrial of the touch for writing tag position information is displayed.

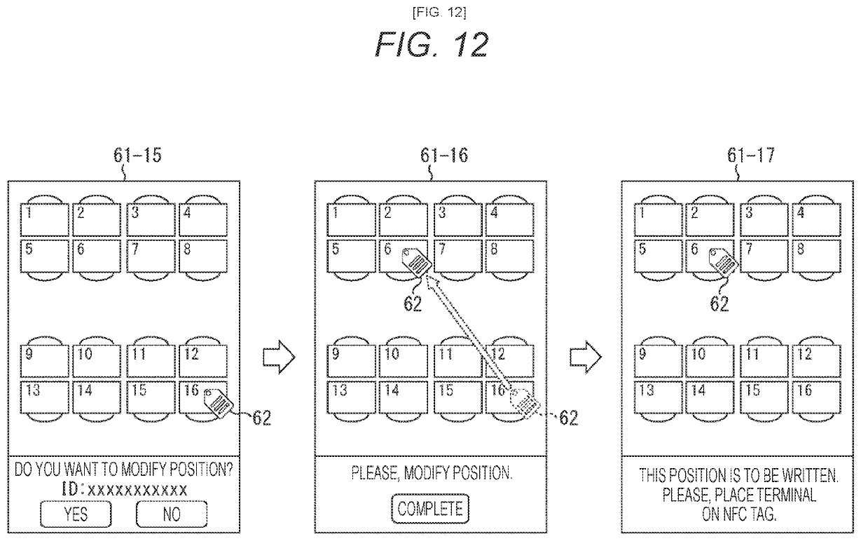

FIG. 12 illustrates display examples of display screens 61-15 to 61-17 displayed on the touch panel display 39 when the tag position information is already written in the tag ID of the NFC tag 13A on which the user has touched the mobile terminal 12 in the writing process of writing tag position information.

In FIG. 12, a case where the tag position information of the NFC tag 13A-16 is written in an NFC tag 13A-6 on which the user has touched the mobile terminal 12 during execution of an association process will be described. In this case, on a map of the display screen 61-15, the tag mark 62 is displayed at a display position according to the tag position information of the NFC tag 13A-16, for example, at a display position superimposed on the image of the desk to which the NFC tag 13-16 is attached. Moreover, on the display screen 61-15, a tag ID of the touched NFC tag 13A-6, and a “Yes” button and a “No” button are displayed together with a message “Do you want to modify position?” to check whether or not to modify the display position of the tag mark 62.

When the user taps the “Yes” button in response to the message, the display of the touch panel display 39 is changed to the display screen 61-16. On the display screen 61-16, a “Complete” button is displayed together with a message “Please modify position.” to prompt modification of the display position of the tag mark 62. In response to this message, the user performs a modification operation of modifying the display position of the tag mark 62 by moving (dragging) the tag mark 62 to the position superimposed on the image of the desk to which the NFC tag 13A-6 is attached while touching the tag mark 62 at the current display position.

Thereafter, when the user taps the “Complete” button, the display of the touch panel display 39 is changed to the display screen 61-17, and a message “This position is to be written. Please, place terminal on NFC tag.” to write the tag position information into the NFC tag 13A-6 according to the tag mark 62 and confirm the modification is displayed.

### <Processing Examples of Association Process and User Position Information Notification Process>

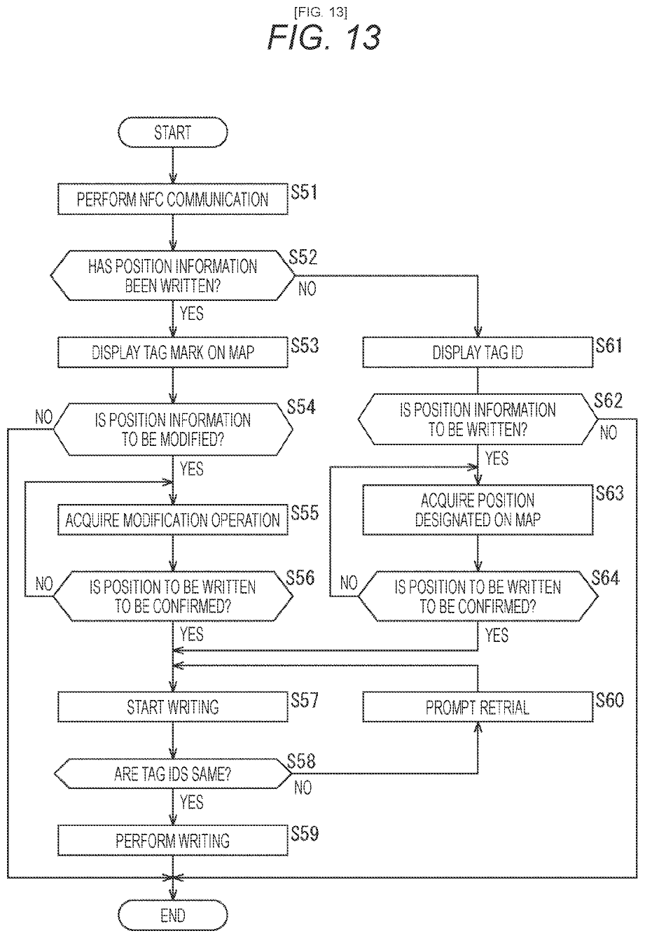

The writing process of writing tag position information in the NFC tag 13A will be described with reference to a flowchart illustrated in FIG. 13.

For example, the processing is started when the mobile terminal 12 touches any NFC tag 13A, and in step S51, the NFC communication unit 35 performs NFC communication with the NFC tag 13A. Then, the NFC communication unit 35 reads a tag ID from the NFC tag 13A touched by the mobile terminal 12, and attempts to read tag position information from the NFC tag 13A. At this time, the NFC communication unit 35 can read tag position information if the tag position information is written in the NFC tag 13A, and cannot read tag position information if there is no tag position information written in the NFC tag 13A.

In step S52, the data processing unit 40 determines whether or not the tag position information is already written in the NFC tag 13A.

In step S52, in a case where the data processing unit 40 determines that the tag position information is already written in the NFC tag 13A, that is, in a case where the NFC communication unit 35 has read the tag position information from the NFC tag 13A in step S51, the processing proceeds to step S53.

In step S53, the display control unit 38 displays the tag mark 62 on a map of the display screen 61 on the basis of the tag position information read by the NFC communication unit 35 in step S51 (see the display screen 61-15 in FIG. 12).

In step S54, the data processing unit 40 determines whether or not to modify the tag position information of the NFC tag 13A touched by the mobile terminal 12.

In step S54, in a case where the data processing unit 40 determines to modify the tag position information of the NFC tag 13A, for example, in a case where the user operates the “Yes” button displayed on the display screen 61-15 of FIG. 12, the processing proceeds to step S55.

In step S55, when the user performs a modification operation of modifying a display position of the tag mark 62, the touch panel display 39 acquires the modification operation as described with reference to the display screen 61-16 illustrated in FIG. 12. Then, the display control unit 38 performs display control on the touch panel display 39 so as to display the tag mark 62 at the display position according to the modification operation.

In step S56, the data processing unit 40 modifies the tag position information of the NFC tag 13A touched by the mobile terminal 12 with a position according to the display position modified by the modification operation acquired in step S55, and determines whether or not to confirm the tag position information to be written in the NFC tag 13A.

In step S56, in a case where the data processing unit 40 determines to confirm the tag position information to be written in the NFC tag 13A, for example, in a case where the user operates the “Complete” button displayed on the display screen 61-16 of FIG. 12, the processing proceeds to step S57. Note that the acquisition of the modification operation in step S55 is continuously performed until it is determined to confirm the writing of the modified tag position information with respect to the tag ID, for example, until the “Complete” button displayed on the display screen 61-16 in FIG. 12 is operated.

In step S57, the NFC communication unit 35 acquires current position information of the mobile terminal 12 from the positioning processing unit 36, and performs NFC communication with the NFC tag 13A in order to start writing of the position information as the tag position information into the NFC communication unit 35A. At this time, the display screen 61-17 of FIG. 12 is displayed on the touch panel display 39 to prompt the user to touch the NFC tag 13A with the mobile terminal 12, and the NFC communication unit 35 reads a tag ID of the NFC tag 13A touched by the mobile terminal 12 before writing the tag position information.

In step S58, the data processing unit 40 determines whether or not the tag ID read by the NFC communication unit 35 in step S57 is the same as the tag ID read by the NFC communication unit 35 in step S51. That is, it is determined whether the NFC tag 13A to which the tag position information is to be written is the same as the NFC tag 13A touched by the mobile terminal 12 at the start of the association process.

In step S58, in a case where the data processing unit 40 determines that the tag IDs are the same, the processing proceeds to step S59.

In step S59, the NFC communication unit 35 performs the writing of the tag position information started in step S57. Then, after the NFC communication unit 35 writes the tag position information in the NFC tag 13A, the display control unit 38 causes the touch panel display 39 to display a message (see the display screen 61-13 in FIG. 11) to issue a notification that the writing is completed, and the processing is ended.

On the other hand, in a case where the data processing unit 40 determines that the tag IDs are not the same in step S58, the processing proceeds to step S60.

In step S60, the display control unit 38 causes the touch panel display 39 to display a message (see the display screen 61-14 in FIG. 11) to prompt retrial of the touch for writing tag position information. Thereafter, the processing returns to step S57, and similar processing is repeated subsequently.

On the other hand, in a case where the data processing unit 40 determines that the tag position information is not written in the NFC tag 13A yet in step S52, that is, in a case where the NFC communication unit 35 has not read tag position information from the NFC tag 13A in step S51, the processing proceeds to step S61.

In step S61, the display control unit 38 causes the touch panel display 39 to display the tag ID read from the NFC tag 13A by the NFC communication unit 35 in step S51 and a message prompting designation of the NFC tag 13A (see the display screen 61-9 in FIG. 10).

In step S62, the data processing unit 40 determines whether or not to write tag position information in the NFC tag 13A, and in a case where it is determined to write the tag position information in the NFC tag 13A, the processing proceeds to step S63.

In step S63, as described with reference to the display screen 61-10 illustrated in FIG. 10, when the user performs a designation operation of designating position information to be written in the NFC tag 13A, the touch panel display 39 acquires the designation operation.

In step S64, the data processing unit 40 determines whether or not to confirm the tag position information to be written in the NFC tag 13A touched by the mobile terminal 12 by using the position information according to the designation operation acquired by the touch panel display 39 in step S63 as the tag position information of the NFC tag 13A.

In step S64, in a case where the data processing unit 40 determines to confirm the tag position information to be written in the NFC tag 13A, for example, in a case where the user operates the “Yes” button displayed on the display screen 61-10 in FIG. 10, the processing proceeds to step S57, and similar processing is performed subsequently. Note that the acquisition of the designation operation in step S63 is continuously performed until it is determined to confirm the tag position information to be written in the NFC tag 13A, for example, until the “Yes” button displayed on the display screen 61-10 in FIG. 10 is operated.

On the other hand, the processing is ended in a case where the data processing unit 40 determines not to modify the tag position information of the NFC tag 13A in step S54 or determines not to write the tag position information in the NFC tag 13A in step S62.

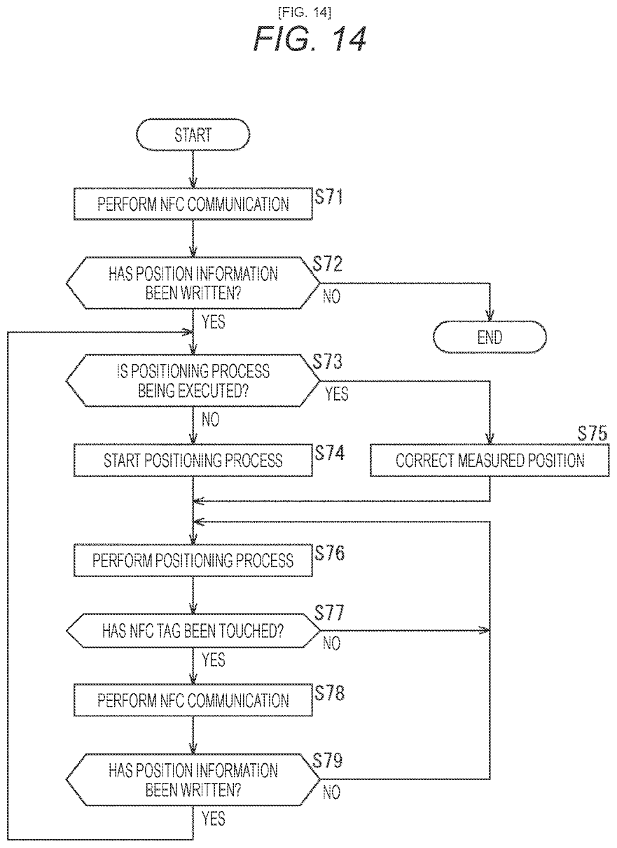

The user position information notification process will be described with reference to a flowchart illustrated in FIG. 14.

For example, the processing is started when the mobile terminal 12 touches any NFC tag 13A, and in step S71, the NFC communication unit 35 performs NFC communication with the NFC tag 13A. Then, the NFC communication unit 35 reads a tag ID from the NFC tag 13A touched by the mobile terminal 12, and attempts to read tag position information from the NFC tag 13A. At this time, the NFC communication unit 35 can read tag position information if the tag position information is written in the NFC tag 13A, and cannot read tag position information if there is no tag position information written in the NFC tag 13A.

In step S72, the data processing unit 40 determines whether or not the tag position information is already written in the NFC tag 13A, and in a case where it is determined that the tag position information is not written in the NFC tag 13A yet, the processing is ended.

On the other hand, in a case where the data processing unit 40 determines in step S72 that the tag position information is already written in the NFC tag 13A, that is, in a case where the NFC communication unit 35 has read the tag position information from the NFC tag 13A in step S71, the processing proceeds to step S73.

Thereafter, processing similar to that from step S35 to step S39 in FIG. 8 described above is performed from step S73 to step S77.

Then, in step S77, the processing proceeds to step S78 in a case where the NFC communication unit 35 determines that the mobile terminal 12 has touched the NFC tag 13A.

In steps S78 and S79, processing similar to that in steps S71 and S72 described above is performed. Then, in step S79, in a case where the data processing unit 40 determines that tag position information has been associated with a tag ID, the processing returns to step S73, and similar processing is repeatedly performed subsequently.

On the other hand, in a case where it is determined in step S79 that tag position information is not associated with the tag ID yet, the processing returns to step S76, and a positioning process by the positioning processing unit 36 is continuously performed.

### <Accuracy of Tag Position Information>

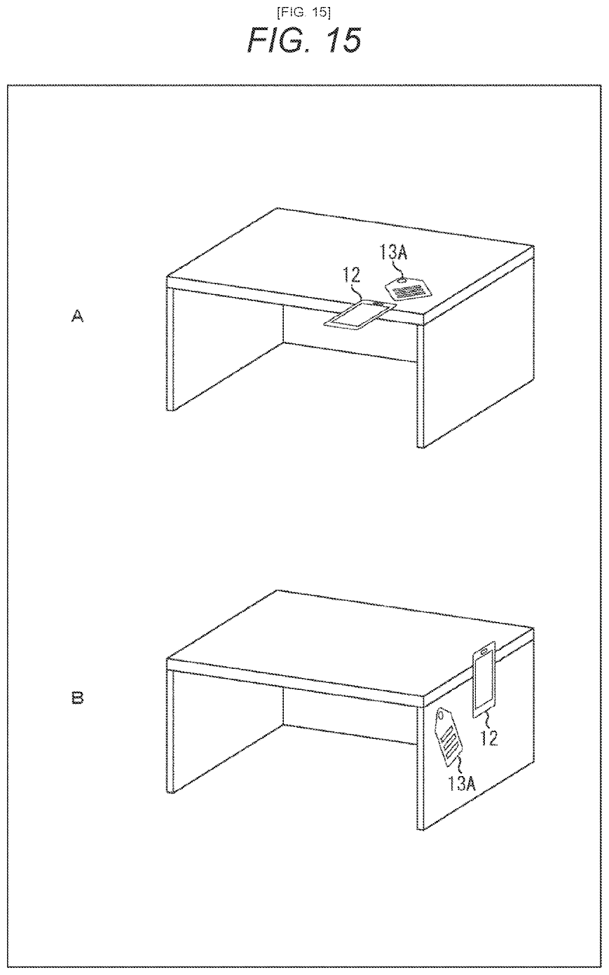

The accuracy of tag position information to be written in the NFC tag 13A will be described with reference to FIGS. 15 to 17.

For example, in a case where the mobile terminal 12 performs the positioning process using geomagnetism, a slight error (for example, error of about 3 to 5 m) in tag position information of the NFC tag 13A is allowable. That is, in this case, the tag position information to be written in the NFC tag 13A is sufficient to indicate any seat.

Furthermore, more accurate tag position information is required in a case where the mobile terminal 12 performs the positioning process without using geomagnetism, that is, in a case where the positioning process is performed using only an acceleration and a gyro. For example, more accurate positioning can be performed if an attitude of the mobile terminal 12 at the time of reading tag position information from the NFC tag 13A can be limited. That is, a position and the attitude of the mobile terminal 12 at a certain time can be specified by reading the tag position information from the NFC tag 13A. Therefore, it is desirable that there is information regarding which position on a seat and in which orientation the NFC tag 13A is attached.

An orientation of the NFC tag 13A attached to a desk will be described with reference to FIG. 15.

A of FIG. 15 illustrates a state in which the NFC tag 13A is attached to an upper surface of the desk and the NFC tag 13A faces upward. In a case where the mobile terminal 12 touches the NFC tag 13A, an attitude of the mobile terminal 12 is horizontal as illustrated in the drawing.

B of FIG. 15 illustrates a state in which the NFC tag 13A is attached to a side surface of the desk and the NFC tag 13A faces the side. In a case where the mobile terminal 12 touches the NFC tag 13A, an attitude of the mobile terminal 12 is vertical as illustrated in the drawing.

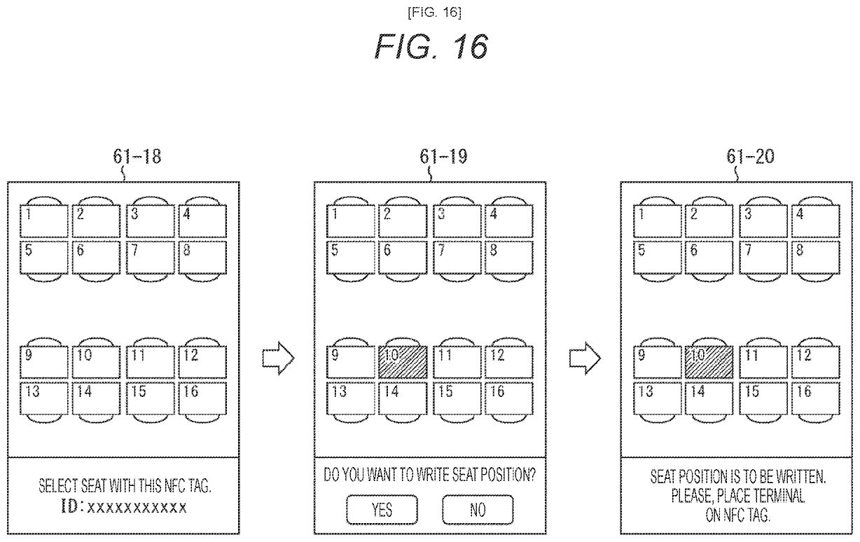

FIG. 16 illustrates display examples of display screens 61-18 to 61-20 displayed on the touch panel display 39 when tag position information is not written in the NFC tag 13A on which the user has touched the mobile terminal 12 in the writing process of writing tag position information in a case where the tag position information to be written in the NFC tag 13A is sufficient to indicate any seat.

In FIG. 16, a case where the user touches an NFC tag A13A-10 with the mobile terminal 12 during execution of the writing process will be described. In this case, on the display screen 61-18, a tag ID of the touched NFC tag A13A-10 is displayed together with a message “Select seat with this tag.” to prompt the user to designate a desk to which the NFC tag A13A-10 on which the user has touched the mobile terminal 12 is attached.

When the user taps an image of a desk to which the NFC tag 13A-16 is attached on a map of the display screen 61-18 and performs a designation operation of designating a position of tag position information to be written in the NFC tag A13A-10 in response to the message, the display of the touch panel display 39 is changed to the display screen 61-19. On a map of the display screen 61-19, a color of an image of a desk to which the NFC tag A13A-10 is attached is changed (hatched in the illustrated example) in order to specify the desk designated by the tap of the user. Then, on the display screen 61-19, a “Yes” button and a “No” button are displayed together with a message “Do you want to write seat position?” to check whether the desk whose color has been changed is correct.

When the user taps the “Yes” button in response to this message, the display of the touch panel display 39 is changed to the display screen 61-20, and a message “Seat position is to be written. Please, place terminal on NFC tag.” to confirm that the tag position information is to be written in the NFC tag A13A-10 at the seat position is displayed.

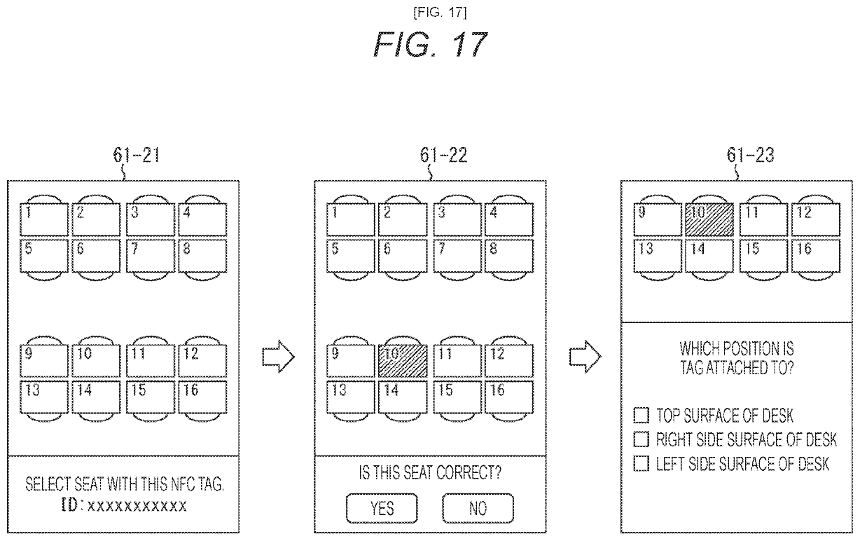

FIG. 17 illustrates display examples of the display screens 61-21 to 61-23 displayed on the touch panel display 39 when tag position information is not written in the NFC tag 13A on which the user has touched the mobile terminal 12 in the writing process of writing tag position information in a case where tag position information including information regarding which position on a seat and in which orientation the NFC tag 13A is attached is to be written.

For example, similarly to the display screens 61-18 and 61-19 illustrated in FIG. 16, a color of an image of the desk to which the NFC tag A13A-10 is attached is changed (hatched in the illustrated example) using the display screens 61-21 and 61-22.

Then, when a “Yes” button on the display screen 61-22 is tapped, the display of the touch panel display 39 is changed to the display screen 61-23. On the display screen 61-23, a user interface for designating an orientation of the NFC tag A13A-10 is displayed, and the user can select any one of “Top surface of desk”, “Right side surface of desk”, and “Left side surface of desk”. Then, tag position information including information indicating the orientation of the NFC tag A13A-10 is written in the NFC tag A13A-10 according to the user's selection.

### <Processing Example of Positioning Process>

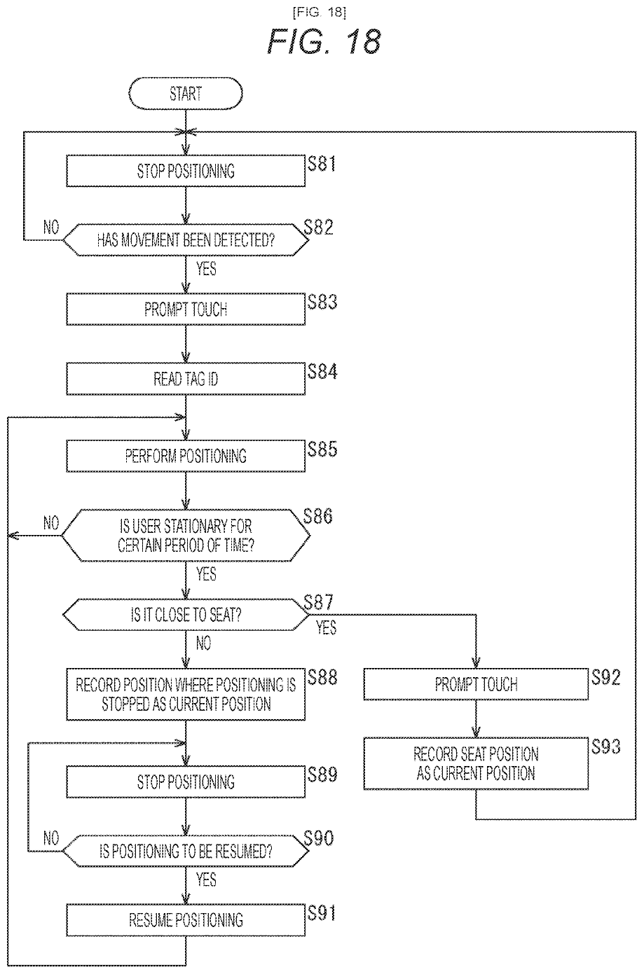

The positioning process performed in step S38 in FIG. 8 will be described with reference to a flowchart illustrated in FIG. 18.

For example, when the positioning processing unit 36 detects that the user is stationary for a certain period of time due to seating on the basis of outputs of the magnetic sensor 31, the acceleration sensor 32, and the gyro 33 during execution of the positioning process, the positioning processing unit 36 stops positioning in step S81.

In step S82, the positioning processing unit 36 determines whether or not a movement of the user leaving the seat has been sensed on the basis of outputs of the magnetic sensor 31, the acceleration sensor 32, and the gyro 33.

In step S82, in a case where the positioning processing unit 36 determines that the movement of the user leaving the seat has not been sensed, the processing returns to step S81, and the positioning processing unit 36 continues to stop positioning. On the other hand, in a case where the positioning processing unit 36 determines in step S82 that the movement of the user leaving the seat has been sensed, the processing proceeds to step S83.

In step S83, the display control unit 38 performs display control on the touch panel display 39 so as to display a comment prompting the user to touch the NFC tag 13 with the mobile terminal 12. Then, when the NFC communication unit 35 detects that the mobile terminal 12 has touched the NFC tag 13, the processing proceeds to step S84.

In step S84, the NFC communication unit 35 reads a tag ID from the NFC tag 13, and the positioning processing unit 36 resumes positioning.

In step S85, the positioning processing unit 36 measures a position of the user on the basis of outputs of the magnetic sensor 31, the acceleration sensor 32, and the gyro 33.

In step S86, the positioning processing unit 36 determines whether or not the user is stationary for a certain period of time on the basis of outputs of the magnetic sensor 31, the acceleration sensor 32, and the gyro 33.

In step S86, in a case where the positioning processing unit 36 determines that the user is not stationary for the certain period of time, that is, in a case where the user is moving, the processing returns to step S85, and the positioning processing unit 36 continues the positioning. On the other hand, in a case where the positioning processing unit 36 determines in step S86 that the user is stationary for the certain period of time, the processing proceeds to step S87.

In step S87, the positioning processing unit 36 determines whether or not a position where the user is determined to be stationary is near a seat.

In step S87, in a case where the positioning processing unit 36 determines that the position where the user is determined to be stationary is not near any seat, the processing proceeds to step S88.

In step S88, the positioning processing unit 36 records the position where positioning is to be stopped as a current position, and stops the positioning in step S89.

In step S90, the positioning processing unit 36 determines whether or not to resume positioning on the basis of outputs of the magnetic sensor 31, the acceleration sensor 32, and the gyro 33. For example, the positioning processing unit 36 determines to resume positioning when a movement of the user is detected, and stops positioning until it is determined to resume positioning.

In a case where the positioning processing unit 36 determines in step S90 to resume positioning, the processing proceeds to step S91 to resume positioning, and then, the processing returns to step S85, and similar processing is repeatedly performed subsequently.

On the other hand, in a case where the positioning processing unit 36 determines in step S87 that the position where the user is determined to be stationary is near a seat, the processing proceeds to step S92.

In step S92, the display control unit 38 performs display control on the touch panel display 39 so as to display a comment prompting the user to touch the NFC tag 13 with the mobile terminal 12. Then, when the NFC communication unit 35 detects that the mobile terminal 12 has touched the NFC tag 13 and reads a tag ID from the NFC tag 13, the processing proceeds to step S93.

In step S93, the positioning processing unit 36 records tag position information associated with the tag ID read from the NFC tag 13 by the mobile terminal 12 in step S92, that is, a seat position of a desk to which the NFC tag 13 is attached as a current position. Thereafter, the processing returns to step S81, and similar processing is repeated subsequently.

As described above, the positioning system 11 stops the positioning by the positioning processing unit 36 when sensing a situation in which the mobile terminal 12 is not moving, and thus, can perform the positioning process with lower power consumption, for example. Furthermore, when the positioning by the positioning processing unit 36 is stopped, the user position information can be fixed at such a place.

Moreover, for example, in a case where the user moves from the seat, the user position information at the time of resuming the positioning process can be corrected by prompting the user to touch the NFC tag 13 attached to the desk so that the occurrence of a positioning error can be suppressed. For example, it is possible to prompt the user to touch the NFC tag 13 when the movement of leaving the seat is sensed. Furthermore, since the positioning application is activated when the mobile terminal 12 touches the NFC tag 13, for example, the time and labor of the user to activate the positioning application is saved so that convenience can be improved.

### <Use Example of Positioning Application>

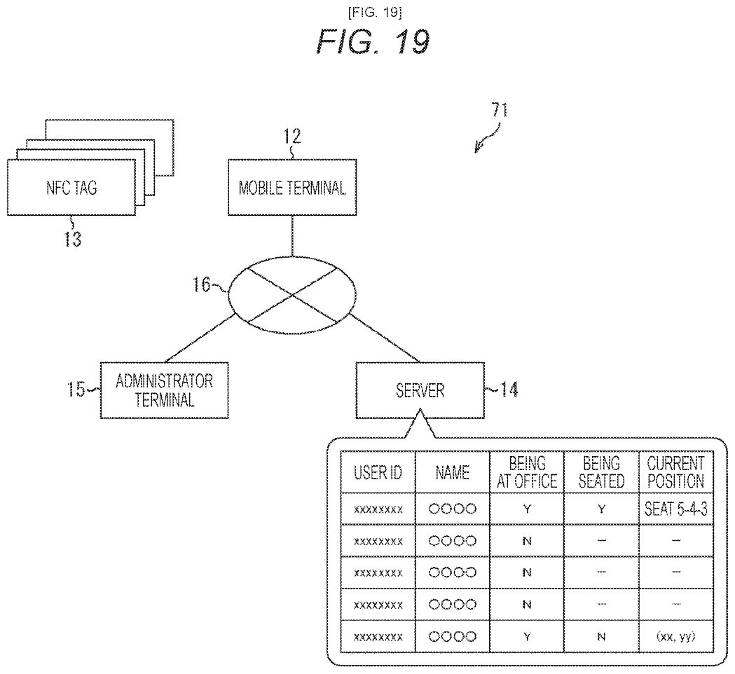

FIG. 19 is a block diagram illustrating a configuration example of an employee checking system in which a positioning application that manages attendance statuses and current positions of employees using user position information acquired by the positioning process of the positioning system 11 in FIG. 2 is executed.

As illustrated in FIG. 19, an employee checking system 71 includes the mobile terminal 12, a plurality of the NFC tags 13, the server 14, and an administrator terminal 15. The mobile terminal 12, the NFC tag 13, and the server 14 are configurations similar to those of the positioning system 11 in FIG. 2. Furthermore, the mobile terminal 12, the server 14, and the administrator terminal 15 are connected via a network 16.

In the employee checking system 71, when a tag ID is read from the NFC tag 13, the mobile terminal 12 transmits a user ID of the mobile terminal 12 and an attendance status of an employee to the server 14. Therefore, the server 14 can register the user ID and the attendance status of the employee. Furthermore, in the employee checking system 71, the mobile terminal 12 acquires tag position information of the NFC tag 13 as an initial position at which the positioning process is started, and transmits the tag position information to the server 14 together with the user ID of the employee. Therefore, the server 14 can register the user ID and a current position of the employee.

Therefore, as illustrated in FIG. 19, in a database of the server 14, a name, an attendance status (whether or not the user is at an office), a seating status (whether or not the user is seated), and a current position (a seat position or a coordinate position) are registered for each user ID.

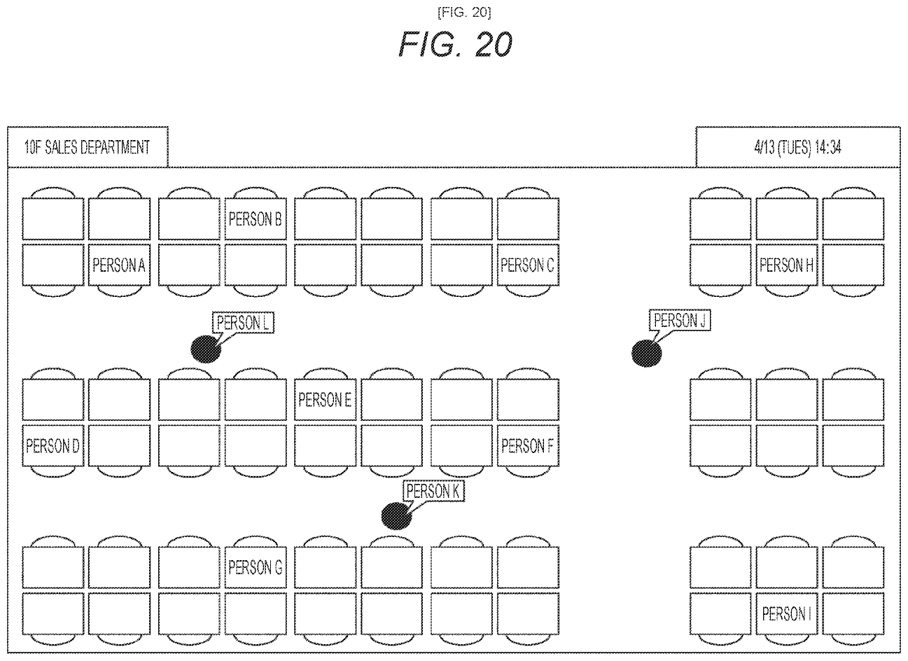

Then, in the employee checking system 71, the administrator terminal 15 executes the positioning application that manages attendance statuses and current positions of employees, inquires of the server 14 about the attendance statuses and the current positions of the employees, and thus, can manage the attendance status and the current position of the employee for every mobile terminal 12, whereby an employee checking screen as illustrated in FIG. 20 can be displayed. As illustrated in FIG. 20, on the employee checking screen, on a map on which images of desks in a department are arranged, a name of an employee who is seated among employees whose attendance statuses are being at the office is displayed to be linked with an image of a desk from which a tag ID has been read by the mobile terminal 12 of the employee, and a name of an employee who is not seated is displayed to be linked with a mark (black circle) indicating a current position of the employee.

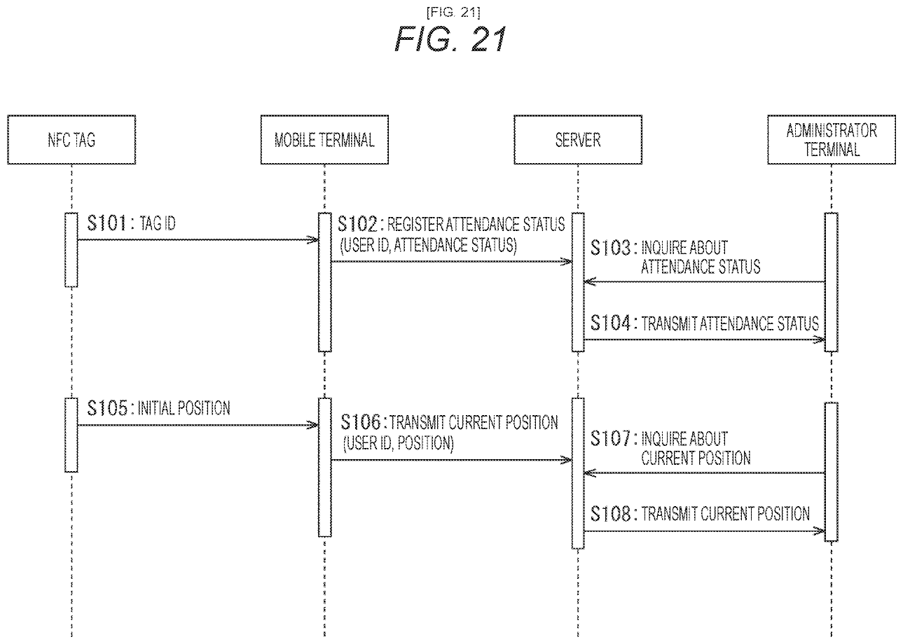

FIG. 21 is a sequence diagram illustrating an employee management process executed in the employee checking system 71.

The mobile terminal 12 reads a tag ID from the NFC tag 13 in step S101, and registers a user ID and an attendance status of an employee in the server 14 in step S102.

In step S103, when the administrator terminal 15 inquires of the server 14 about the attendance status of the employee, the server 14 transmits the attendance status of the employee to the administrator terminal 15 in step S104.

In step S105, the mobile terminal 12 acquires tag position information of the NFC tag 13, obtains a current position of the employee by the positioning process using the tag position information as an initial position or the positioning process in which user position information is corrected with the tag position information, and transmits the user ID and the current position of the employee to the server 14 in step S106.

When the administrator terminal 15 inquires of the server 14 about the current position of the employee in step S107, the server 14 transmits the current position of the employee to the administrator terminal 15 in step S108.

It is possible to check the attendance status and the current position of the employee on the employee checking screen as illustrated in FIG. 20 by executing such an employee management process.

### <Configuration Example of Computer>

Next, a series of the processes described above (an information processing method) may be performed by hardware or can be performed by software. In a case where the series of processes is performed by the software, a program constituting the software is installed on a general-purpose computer, and the like.

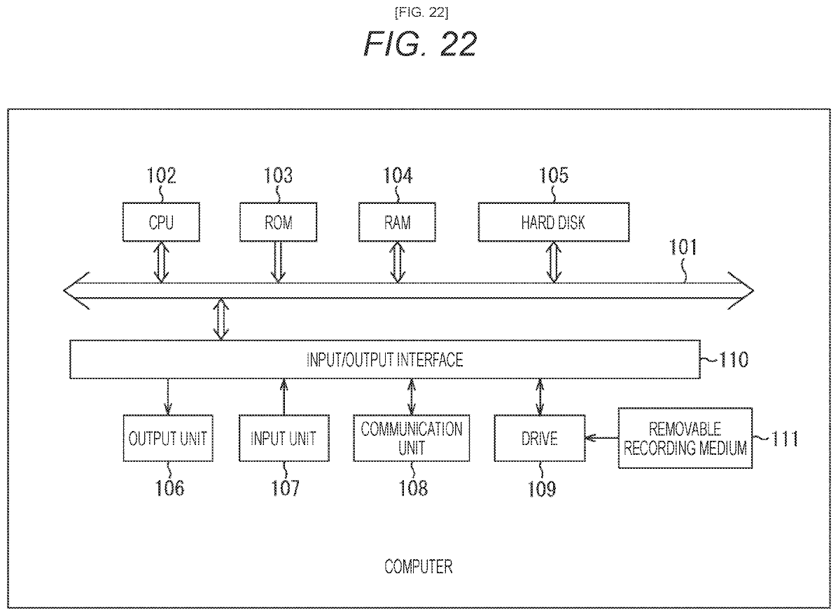

FIG. 22 is a block diagram illustrating a configuration example of an embodiment of a computer on which a program for executing the series of processes described above is installed.

The program can be recorded in advance on a hard disk 105 or ROM 103 as a recording medium incorporated in the computer.

Alternatively, the program can also be stored (recorded) in a removable recording medium 111 driven by a drive 109. Such a removable recording medium 111 can be provided as so-called package software. Here, examples of the removable recording medium 111 include, for example, a flexible disk, a compact disc read only memory (CD-ROM), a magneto optical (MO) disk, a digital versatile disc (DVD), a magnetic disk, a semiconductor memory, and the like.

Note that, in addition to installing the program on the computer from the removable recording medium 111 as described above, the program can be downloaded to the computer via a communication network or a broadcasting network and installed on the hard disk 105 to be incorporated. In other words, for example, the program can be wirelessly transferred from a download site to the computer via an artificial satellite for digital satellite broadcasting, or can be transferred by a wire to the computer via a network such as a local area network (LAN) and the Internet.

The computer has a built-in central processing unit (CPU) 102, and an input/output interface 110 is connected to the CPU 102 via a bus 101.

When a command is input by the user, for example, operating an input unit 107 via the input/output interface 110, accordingly, the CPU 102 executes a program stored in the read only memory (ROM) 103. Alternatively, the CPU 102 loads a program stored in the hard disk 105 into a random access memory (RAM) 104 to execute the program.

Therefore, the CPU 102 performs processing according to the above-described flowchart or processing performed according to the above configuration described with the block diagram. Then, as necessary, the CPU 102 outputs a processing result from an output unit 106, or transmits the processing result from a communication unit 108, and further, causes the hard disk 105 to record the processing result, and the like, via the input/output interface 110, for example.

Note that, the input unit 107 includes a keyboard, a mouse, a microphone, and the like. Furthermore, the output unit 106 includes a liquid crystal display (LCD), a speaker, and the like.

Herein, in the present specification, the processing to be performed by the computer in accordance with the program is not necessarily performed on a time-series basis according to the sequences described in the flowcharts. That is, the processing to be performed by the computer in accordance with the program includes processing to be executed in parallel or independently of one another (parallel processing or object-based processing, for example).

Furthermore, the program may be processed by one computer (one processor) or processed in a distributed manner by a plurality of computers. Moreover, the program may be transferred to a distant computer to be executed.

Moreover, in the present description, a system means a set of a plurality of components (devices, modules (parts), and the like), and it does not matter whether or not all the components are in the same housing. Therefore, a plurality of devices accommodated in separate housings and connected via a network and one device in which a plurality of modules is accommodated in one housing are both systems.

Furthermore, for example, a configuration described as one device (or one processing unit) may be divided and configured as the plurality of the devices (or the processing units). Conversely, configurations described above as a plurality of devices (or processing units) may be combined and configured as one device (or processing unit). Furthermore, it goes without saying that a configuration other than the above-described configurations may be added to the configuration of each device (or each processing unit). Moreover, when the configuration and operation as the entire system are substantially the same, a part of the configuration of a certain device (or processing unit) may be included in the configuration of another device (or another processing unit).

Furthermore, for example, the present technology can be configured as cloud computing in which one function is shared and jointly processed by the plurality of the devices via the network.

Furthermore, for example, the program described above can be executed by any device. In this case, the device is only required to have a necessary function (functional block and the like) and obtain necessary information.

Furthermore, for example, each step described in the flowcharts described above can be executed by one device, or can be executed in a shared manner by the plurality of the devices. Moreover, in a case where a plurality of processes is included in one step, the plurality of processes included in the one step can be executed by one device or shared and executed by the plurality of the devices. In other words, the plurality of processes included in the one step can also be executed as processes of a plurality of steps. Conversely, the processes described as the plurality of the steps can also be collectively executed as one step.

Note that, in the program to be executed by the computer, the processes in steps describing the program may be executed in time series in the order described in the present description, or may be executed in parallel, or independently at a necessary timing such as when a call is made. That is, unless there is a contradiction, the process in the each step may also be executed in an order different from the orders described above. Moreover, the processes in the steps describing the program may be executed in parallel with processes of another program, or may be executed in combination with processes of the other program.

Note that, a plurality of the present technologies that has been described in the present description can each be implemented independently as a single unit unless there is a contradiction. It goes without saying that any plurality of present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

### <Combination Examples of Configurations>

Note that the present technology may also have the following configurations.

(1)

An information processing terminal including:
a reading unit that reads a tag ID from any one of a plurality of tags in which the tag ID for identifying each of the plurality of tags is recorded, the plurality of tags being arranged at a plurality of specific locations, respectively, in advance; and
a positioning processing unit that starts a positioning process in a case where the positioning process is not being executed and corrects a measured position in a case where the positioning process is being executed, by using position information of the tag when the reading unit reads the tag ID.
   (2)

The information processing terminal according to (1) described above, further including
a communication unit that communicates with a server that stores, in a database, association information in which the tag ID is associated with the position information of the tag,
in which the communication unit transmits the tag ID read from the tag by the reading unit to the server, and supplies the position information of the tag to the positioning processing unit when the position information of the tag associated with the tag ID is transmitted from the server.
   (3)

The information processing terminal according to (1) described above, in which
the position information of the tag is written in the tag, and
the reading unit reads the position information of the tag and supplies the position information to the positioning processing unit.
   (4)

The information processing terminal according to (3) described above, in which
when the position information that is already written in the tag is to be modified in a writing process of writing position information in the tag, the position information of the tag is modified in accordance with a modification operation of a user to move a tag mark, displayed on a touch panel display at a display position according to the position information written in the tag, to a modified display position.
   (5)

The information processing terminal according to (3) described above, in which
an orientation of the tag is designated when the position information is written in the tag.
   (6)

The information processing terminal according to any one of (1) to (5) described above, in which
the positioning processing unit stops positioning when detecting that the information processing terminal is stationary for a certain period of time.
   (7)

The information processing terminal according to (6) described above, in which
the positioning processing unit prompts the reading unit to read the tag ID to record the read tag ID as a current position in a case where a position at which the positioning is stopped is near the tag.
   (8)

An information processing method including:
by an information processing terminal,
reading a tag ID from any one of a plurality of tags in which the tag ID for identifying each of the plurality of tags is recorded, the plurality of tags being arranged at a plurality of specific locations, respectively, in advance; and
starting a positioning process in a case where the positioning process is not being executed and correcting a measured position in a case where the positioning process is being executed, by using position information of the tag when reading the tag ID.
(9)

A program for causing a computer of an information processing terminal to execute information processing including:
reading a tag ID from any one of a plurality of tags in which the tag ID for identifying each of the plurality of tags is recorded, the plurality of tags being arranged at a plurality of specific locations, respectively, in advance; and
starting a positioning process in a case where the positioning process is not being executed and correcting a measured position in a case where the positioning process is being executed, by using position information of the tag when reading the tag ID.
   (10)

A management system including:
an information processing terminal including: a reading unit that reads a tag ID from any one of a plurality of tags in which the tag ID for identifying each of the plurality of tags is recorded, the plurality of tags being arranged at a plurality of specific locations, respectively, in advance; and a positioning processing unit that starts a positioning process in a case where the positioning process is not being executed and corrects a measured position in a case where the positioning process is being executed, by using position information of the tag when the reading unit reads the tag ID;
a server that registers user IDs and attendance statuses of employees of a plurality of the information processing terminals transmitted from the plurality of information processing terminals or the user IDs and current positions of the employees of the plurality of information processing terminals transmitted from the plurality of information processing terminals; and
an administrator terminal that makes an inquiry to the server and manages an attendance status and a current position of an employee for each of the plurality of information processing terminals.
   (11)

The management system according to (10) described above, in which
among employees of which attendance statuses are being at an office on a map on which images of desks to which the tags are attached, respectively, are arranged, the administrator terminal
displays a name of an employee who is seated to be linked with an image of a desk from which the tag ID has been read by the information processing terminal of the employee, and
displays a name of an employee who is not seated to be linked with a mark indicating a current position of the employee.
   (12)

A management method performed by a computer of a management system, which includes: an information processing terminal including: a reading unit that reads a tag ID from any one of a plurality of tags in which the tag ID for identifying each of the plurality of tags is recorded, the plurality of tags being arranged at a plurality of specific locations, respectively, in advance; and a positioning processing unit that starts a positioning process in a case where the positioning process is not being executed and corrects a measured position in a case where the positioning process is being executed, by using position information of the tag when the reading unit reads the tag ID; a server; and an administrator terminal, the management method including:
registering user IDs and attendance statuses of employees of a plurality of the information processing terminals transmitted from the plurality of information processing terminals to the server or the user IDs and current positions of the employees of the plurality of information processing terminals transmitted from the plurality of information processing terminals to the server; and
causing the administrator terminal to make an inquiry to the server to manage an attendance status and a current position of an employee for each of the plurality of information processing terminals.
   (13)

A program for causing a computer of a management system, which includes: an information processing terminal including: a reading unit that reads a tag ID from any one of a plurality of tags in which the tag ID for identifying each of the plurality of tags is recorded, the plurality of tags being arranged at a plurality of specific locations, respectively, in advance; and a positioning processing unit that starts a positioning process in a case where the positioning process is not being executed and corrects a measured position in a case where the positioning process is being executed, by using position information of the tag when the reading unit reads the tag ID; a server; and an administrator terminal, to execute management processing including:
registering user IDs and attendance statuses of employees of a plurality of the information processing terminals transmitted from the plurality of information processing terminals to the server or the user IDs and current positions of the employees of the plurality of information processing terminals transmitted from the plurality of information processing terminals to the server; and
causing the administrator terminal to make an inquiry to the server to manage an attendance status and a current position of an employee for each of the plurality of information processing terminals.

Note that, the present embodiment is not limited to the embodiments described above, and various alterations can be made without departing from the gist of the present disclosure. Furthermore, the effects described herein are merely examples and are not limited, and other effects may be provided.

### REFERENCE SIGNS LIST

11 Positioning system
12 Mobile terminal
13 NFC tag
14 Server
15 Administrator terminal
16 Network
31 Magnetic sensor
32 Acceleration sensor
33 Gyro
34 Geomagnetic map holding unit
35 NFC communication unit
36 Positioning processing unit
37 Communication unit
38 Display control unit
39 Touch panel display
40 Data processing unit
51 PDR processing unit
52 Filter
61 Display screen
62 Tag Mark
63 Positioning mark
64 Pin mark
71 Employee checking system

1. An information processing terminal comprising:
a reading unit that reads a tag ID from any one of a plurality of tags in which the tag ID for identifying each of the plurality of tags is recorded, the plurality of tags being arranged at a plurality of specific locations, respectively, in advance; and
a positioning processing unit that starts a positioning process in a case where the positioning process is not being executed and corrects a measured position in a case where the positioning process is being executed, by using position information of the tag when the reading unit reads the tag ID.

2. The information processing terminal according to claim 1, further comprising
a communication unit that communicates with a server that stores, in a database, association information in which the tag ID is associated with the position information of the tag,
wherein the communication unit transmits the tag ID read from the tag by the reading unit to the server, and supplies the position information of the tag to the positioning processing unit when the position information of the tag associated with the tag ID is transmitted from the server.

3. The information processing terminal according to claim 1, wherein
the position information of the tag is written in the tag, and
the reading unit reads the position information of the tag and supplies the position information to the positioning processing unit.

4. The information processing terminal according to claim 3, wherein
when the position information that is already written in the tag is to be modified in a writing process of writing position information in the tag, the position information of the tag is modified in accordance with a modification operation of a user to move a tag mark, displayed on a touch panel display at a display position according to the position information written in the tag, to a modified display position.

5. The information processing terminal according to claim 3, wherein
an orientation of the tag is designated when the position information is written in the tag.

6. The information processing terminal according to claim 1, wherein
the positioning processing unit stops positioning when detecting that the information processing terminal is stationary for a certain period of time.

7. The information processing terminal according to claim 6, wherein
the positioning processing unit prompts the reading unit to read the tag ID to record the read tag ID as a current position in a case where a position at which the positioning is stopped is near the tag.

8. An information processing method comprising:
by an information processing terminal,
reading a tag ID from any one of a plurality of tags in which the tag ID for identifying each of the plurality of tags is recorded, the plurality of tags being arranged at a plurality of specific locations, respectively, in advance; and
starting a positioning process in a case where the positioning process is not being executed and correcting a measured position in a case where the positioning process is being executed, by using position information of the tag when reading the tag ID.

9. A program for causing a computer of an information processing terminal to execute information processing comprising:
reading a tag ID from any one of a plurality of tags in which the tag ID for identifying each of the plurality of tags is recorded, the plurality of tags being arranged at a plurality of specific locations, respectively, in advance; and
starting a positioning process in a case where the positioning process is not being executed and correcting a measured position in a case where the positioning process is being executed, by using position information of the tag when reading the tag ID.

10. A management system comprising:
an information processing terminal including: a reading unit that reads a tag ID from any one of a plurality of tags in which the tag ID for identifying each of the plurality of tags is recorded, the plurality of tags being arranged at a plurality of specific locations, respectively, in advance; and a positioning processing unit that starts a positioning process in a case where the positioning process is not being executed and corrects a measured position in a case where the positioning process is being executed, by using position information of the tag when the reading unit reads the tag ID;
a server that registers user IDs and attendance statuses of employees of a plurality of the information processing terminals transmitted from the plurality of information processing terminals or the user IDs and current positions of the employees of the plurality of information processing terminals transmitted from the plurality of information processing terminals; and
an administrator terminal that makes an inquiry to the server and manages an attendance status and a current position of an employee for each of the plurality of information processing terminals.

11. The management system according to claim 10, wherein
among employees of which attendance statuses are being at an office on a map on which images of desks to which the tags are attached, respectively, are arranged, the administrator terminal
displays a name of an employee who is seated to be linked with an image of a desk from which the tag ID has been read by the information processing terminal of the employee, and
displays a name of an employee who is not seated to be linked with a mark indicating a current position of the employee.

12. A management method performed by a computer of a management system, which includes: an information processing terminal including: a reading unit that reads a tag ID from any one of a plurality of tags in which the tag ID for identifying each of the plurality of tags is recorded, the plurality of tags being arranged at a plurality of specific locations, respectively, in advance; and a positioning processing unit that starts a positioning process in a case where the positioning process is not being executed and corrects a measured position in a case where the positioning process is being executed, by using position information of the tag when the reading unit reads the tag ID; a server; and an administrator terminal, the management method comprising:
registering user IDs and attendance statuses of employees of a plurality of the information processing terminals transmitted from the plurality of information processing terminals to the server or the user IDs and current positions of the employees of the plurality of information processing terminals transmitted from the plurality of information processing terminals to the server; and
causing the administrator terminal to make an inquiry to the server to manage an attendance status and a current position of an employee for each of the plurality of information processing terminals.

13. A program for causing a computer of a management system, which includes: an information processing terminal including: a reading unit that reads a tag ID from any one of a plurality of tags in which the tag ID for identifying each of the plurality of tags is recorded, the plurality of tags being arranged at a plurality of specific locations, respectively, in advance; and a positioning processing unit that starts a positioning process in a case where the positioning process is not being executed and corrects a measured position in a case where the positioning process is being executed, by using position information of the tag when the reading unit reads the tag ID; a server; and an administrator terminal, to execute management processing comprising:
registering user IDs and attendance statuses of employees of a plurality of the information processing terminals transmitted from the plurality of information processing terminals to the server or the user IDs and current positions of the employees of the plurality of information processing terminals transmitted from the plurality of information processing terminals to the server; and
causing the administrator terminal to make an inquiry to the server to manage an attendance status and a current position of an employee for each of the plurality of information processing terminals.
